(19) United States
(12) Patent Application Publication
(10) Pub. No.: US 2019/0019219 A1
(43) Pub. Date: Jan. 17, 2019

(54) DETERMINATION APPARATUS, METHOD OF DETERMINATION, AND NON-TRANSITORY COMPUTER READABLE STORAGE MEDIUM

(71) Applicant: YAHOO JAPAN CORPORATION, Tokyo (JP)

(72) Inventor: Takamitsu IRIYAMA, Tokyo (JP)

(73) Assignee: YAHOO JAPAN CORPORATION, Tokyo (JP)

(21) Appl. No.: 16/026,661

(22) Filed: Jul. 3, 2018

(30) Foreign Application Priority Data
Jul. 12, 2017 (JP) 2017-136647

(51) Int. Cl. G06Q 30/02; H04W 4/33; H04W 4/021; H04W 4/029

(52) U.S. Cl. CPC G06Q 30/0261; G06Q 30/0255; H04W 4/029; H04W 4/021; H04W 4/33

(57) ABSTRACT

According to one aspect of an embodiment a determination apparatus includes a reception unit that receives a notification, indicating that a user has visited a certain facility, from a terminal apparatus having a notification function that outputs the notification when the user visits the facility. The determination apparatus includes an estimation unit that estimates, on the basis of a statistical relation between a history of number of the notifications and a history of a using state of the facility, number of users who are visiting the certain facility from number of the notifications received in a certain period. The determination apparatus includes a determination unit that determines whether a new user is able to use the certain facility on the basis of a determination result by the estimation unit.

### CROSS-REFERENCE TO RELATED APPLICATIONS

The present application claims priority to and incorporates by reference the entire contents of Japanese Patent Application No. 2017-136647 filed in Japan on Jul. 12, 2017.

### BACKGROUND OF THE INVENTION

### 1. Field of the Invention

The present invention relates to a determination apparatus, a method of determination, and a non-transitory computer readable storage medium.

### 2. Description of the Related Art

A technique has been conventionally known that detects visit states and using states of facilities by users and provides certain services on the basis of detection results. As an example of such a technology, a technique is known that, on the basis of the state of tables installed in a shop and the number of customers, determines whether the shop is at full occupancy.

Japanese Laid-open Patent Publication No. 2005-070956.

In recent years, a beacon technique is known that installs a transmission apparatus that transmits a certain signal in a facility, receives a notification that the certain signal has been received from a terminal apparatus used by a user, and thereby detects a visit to the facility by the user. Processing can be provided that identifies the number of users who have visited a shop and identifies whether the shop is at full occupancy on the basis of the identified number using such a technique.

However, the technique described above cannot necessarily appropriately identify full occupancy. The technique described above cannot accurately identify the number of users who have visited the facility when there are some users who use a terminal apparatus that does not have a notification function for outputting the notification that the certain signal has been received among the users who have visited the facility, for example.

### SUMMARY OF THE INVENTION

It is an object of the present invention to at least partially solve the problems in the conventional technology.

According to one aspect of an embodiment a determination apparatus includes a reception unit that receives a notification, indicating that a user has visited a certain facility, from a terminal apparatus having a notification function that outputs the notification when the user visits the facility. The determination apparatus includes an estimation unit that estimates, on the basis of a statistical relation between a history of number of the notifications and a history of a using state of the facility, number of users who are visiting the certain facility from number of the notifications received in a certain period. The determination apparatus includes a determination unit that determines whether a new user is able to use the certain facility on the basis of a determination result by the estimation unit. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for illustrating an example of working effects exhibited by an information provision apparatus according to an embodiment;

FIG. 2 is a diagram for illustrating an example of a functional configuration of the information provision apparatus according to the embodiment;

FIG. 3 is a diagram of an example of information registered in a beacon log database according to the embodiment;

FIG. 4 is a diagram of an example of information registered in a shop database according to the embodiment;

FIG. 5 is a diagram of an example of information registered in a user database according to the embodiment;

FIG. 6 is a diagram of an example of information registered in a reward database according to the embodiment;

FIG. 7 is a flowchart of an example of a procedure of determination processing executed by the information provision apparatus according to the embodiment;

FIG. 8 is a flowchart of an example of a procedure of processing to correct a statistical model for use in the determination processing by the information provision apparatus according to the embodiment;

FIG. 9 is a flowchart of an example of a procedure of provision processing executed by the information provision apparatus according to the embodiment;

FIG. 10 is a flowchart of an example of a procedure of coupon provision processing executed by the information provision apparatus according to the embodiment; and

FIG. 11 is a flowchart of an example of a procedure of privilege provision processing executed by the information provision apparatus according to the embodiment.

### DETAILED DESCRIPTION OF THE PREFERRED EMBODIMENTS

The following describes modes for performing a determination apparatus, a method of determination, and a non-transitory computer readable storage medium according to the present application (hereinafter, referred to as “embodiments”) in detail with reference to the accompanying drawings. These embodiments do not limit the determination apparatus, the method of determination, or the non-transitory computer readable storage medium according to the present application. In the following embodiments, the same parts and processing are denoted by the same reference symbols, and a duplicate description is omitted.

The following description describes an information provision apparatus 10 that executes provision processing to provide, when a facility visited by a user U1 satisfies a certain condition, the user U1 with information on another facility, determination processing to determine whether a facility is at full occupancy, coupon provision processing to provide the user U1 with a certain coupon only when the user U1 is comparing a plurality of facilities with each other, and privilege provision processing to provide the user U1 with a privilege in accordance with a time during which a user has stayed at a facility (hereinafter, may be collectively referred to as “pieces of processing”). In other words, the information provision apparatus 10 is an example of a provision apparatus or a determination apparatus that executes the various kinds of processing described above.

The following description describes an example in which the various kinds of processing described above are executed for a shop S1 providing foods and drinks (a restaurant, for example) as a facility; embodiments are not limited to this example. The information provision apparatus 10 can apply the provision processing, the determination processing, the coupon provision processing, and the privilege provision processing described below to any facilities such as halls in which events are being held, community centers, libraries, movie theaters, bathing facilities, accommodations such as hotels, amusement parks, and various kinds of attractions, for example.

1. Outline of Pieces of Processing

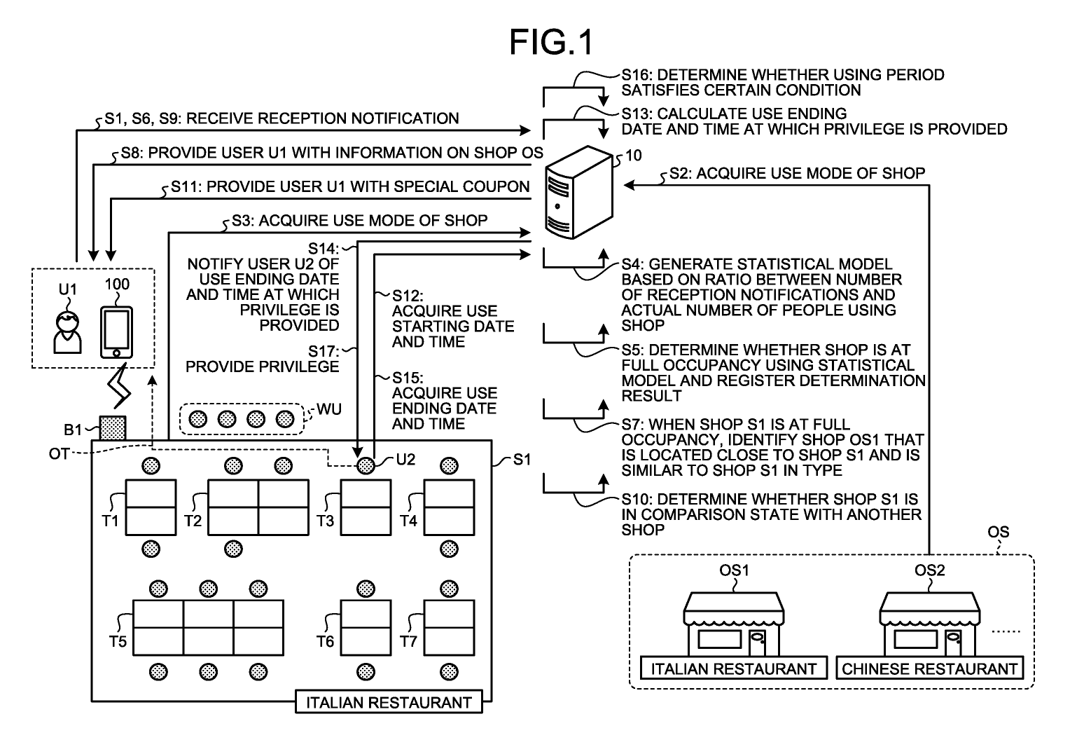

The following first describes the concepts of the pieces of processing executed by the information provision apparatus 10 with reference to FIG. 1. FIG. 1 is a diagram for illustrating an example of working effects exhibited by the information provision apparatus according to the embodiment. The information provision apparatus 10 is an information provision apparatus that is implemented by a single or a plurality of information provision apparatuses such as a server apparatus or a cloud system, for example and is communicable with a terminal apparatus 100 used by the user U1 via a network N such as a mobile communication network or a wireless local area network (LAN). Although the example illustrated in FIG. 1 illustrates the terminal apparatus 100 used by the user U1, the information provision apparatus 10 may be communicable with any number of terminal apparatuses 100 used by any number of users. In the example illustrated in FIG. 1, users other than the user U1 are indicated by circles.

The terminal apparatus 100 is a mobile terminal such as a smartphone, a tablet terminal, or a personal digital assistant (PDA) or an information processing apparatus such as a notebook personal computer (PC), for example. The terminal apparatus 100 has a function of, upon receiving a signal transmitted from an access point, a beacon, or the like (hereinafter, collectively referred to as a “beacon signal”) installed in the shop S1 or other shops OS1 and 0S2 (hereinafter, may be collectively referred to as a “shop OS”), transmitting a notification that the beacon signal has been received (hereinafter, collectively referred to as a “reception notification) to the information provision apparatus 10.

A transmission apparatus B1 that transmits the beacon signal is installed in the shop S1, for example. The transmission apparatus B1 transmits a signal indicating identification information for identifying the shop S1 (an identifier of the shop S1, for example) via a wireless local area network (LAN), Bluetooth (registered trademark), or the like. The terminal apparatus 100 has a notification function of, upon receiving the beacon signal transmitted by the transmission apparatus B1, transmitting the reception notification indicating identification information indicated by the received beacon signal (a beacon identifier (ID), for example) to the information provision apparatus 10. The notification function may be implemented by hardware of the terminal apparatus 100 or implemented by an application that causes the terminal apparatus 100 to exhibit the notification function by being downloaded by the terminal apparatus 100 from any server apparatus and being installed. Not all terminal apparatuses 100 of all users related to the execution of the pieces of processing are required to have the notification function; partial terminal apparatuses 100 may have the notification function.

A service can be provided that that detects whether a user has visited a shop using such a beacon signal and executes various processing in accordance with a detection result. When the terminal apparatus 100 of the user U1 receives a beacon signal containing the identification information of the shop S1 after the user U1 was provided with information on the shop S1, the terminal apparatus 100 is caused to display a message such as “Will you check in?” and when an operation to check in is performed, a reception notification indicating the identification information of the shop S1 is transmitted from the terminal apparatus 100 of the user U1 to the information provision apparatus 10, for example. A check-in service can be provided in which, when receiving the reception notification indicating the identification information of the shop S1 from the terminal apparatus 100 of the user U1, the information provision apparatus 10 determines that the user U1 has been guided to the shop S1, receives a reward for the guidance of the user U1 from the shop S1, and provides the user U1 with an incentive with the reward as a fund.

A technique can be provided that determines whether each user is staying at the shop S1 on the basis of whether the reception notification indicating the identification information of the shop S1 has been received from the terminal apparatus 100 of each user and estimates the number of users who are staying at the shop S1 on the basis of a determination result. A technique can be provided that visualizes whether the shop S1 is at full occupancy and the number of seats in stock of the shop S1 in real time using such a technique. A technique can be provided that estimates how long each user has stayed at the shop S1 using such a technique.

1-1. Outline of Provision Processing

A conventional technique is known that acquires, via a shop terminal or the like installed in the shop S1, vacancy information of the shop and provides the user with the vacancy information of a shop that satisfies desired conditions input by the user U1. However, in such a technique, during a period from the provision of information that there is a vacancy in the shop S1 to the visit to the shop by the user U1, there is a risk that another user may enter the shop S1 to fill the vacancy. Thus, when the user U1 visits the shop S1 even though the shop S1 is at full occupancy, the user U1 has to search for another shop close to the shop S1 or another shop similar to the shop S1, which requires time and effort. In addition, when the user U1 is sent from the shop S1 to the other shop OS having a vacancy, although the vacancy of the shop OS as a customer sending destination can be filled, simply sending the user U1 to the other shop OS is not sending a user with conditions (per-customer spending, the number of people, and a staying time, for example) desired by the shop as a customer sending destination.

Given these circumstances, the information provision apparatus 10 executes the following provision processing. First, the information provision apparatus 10 determines whether a first condition about the using state of a first facility (the shop S1, for example) is satisfied. When the first condition is satisfied, the information provision apparatus 10 searches for a second facility (a shop close to the shop S1 among the shops OS, for example) the relation with the first facility of which satisfies a certain second condition. The information provision apparatus 10 then provides the user U1 with a search result. When the user U1 visits the shop S1, if the shop S1 is at full occupancy, the information provision apparatus 10 provides the user U1 with information on another shop OS located close to the shop S1, the shop being similar to the shop S1 (the shop OS1, which is an Italian restaurant being the same as the shop S1, for example), for example.

1-2. Outline of Determination Processing

A technique can be provided that identifies the location of each user using positional information acquired by Global Positioning System (GPS) or the like or the beacon signal, estimates the number of users who are visiting the shop S1 on the basis of a determination result, and determines whether the shop S1 is at full occupancy on the basis of an estimation result. However, such a technique cannot appropriately identify the number of users who are visiting the shop S1 when only the terminal apparatuses 100 used by partial users among the users who have visited the shop S1 have the notification function. In other words, even when the fullness/vacancy of the shop S1 is attempted to be estimated from an application that transmits the beacon signal or the positional information, not all the users using the shop S1 necessarily have the terminal apparatus 100 that executes the application (that is, the terminal apparatus 100 having the notification function), and thus the degree of congestion cannot be determined.

Given these circumstances, the information provision apparatus 10 executes the following determination processing. First, from the terminal apparatus 100 having the notification function that, when each user visits the shop S1, outputs a reception notification that the user has visited the shop S1, the information provision apparatus 10 receives the reception notification. The information provision apparatus 10 then estimates the number of users who are visiting the shop S1 from the number of notifications received in a certain period on the basis of a statistical relation between the history of the number of notifications and the history of the using state of the shop S1.

1-3. Outline of Coupon Provision Processing

A technique is known that provides the user U1 with a coupon that can be used at the shop S1 or the shop OS. In such a coupon, any details such as the discount rate or the discount details of the amount of money used (“free for one of them”, for example) and the provision of a special menu are set by the shop side. In such a coupon, applicable conditions may be set; various kinds of conditions may be set such as conditions about the number of people such as “applicable to three or more”, conditions about a date and time (including a day of the week) such as “applicable only to weekdays” or “inapplicable to lunch”, and conditions about the amount of money used such as “applicable to 5,000 yen or more”, for example.

However, it is difficult to appropriately set such a coupon. It is considered that when the shop S1 provides users with a coupon with a more favorable condition than the shop OS (a coupon with a higher discount rate or a coupon with a looser condition, for example), more users can be guided to the shop S1, for example. However, if the other shop OS provides users with a coupon with a further more favorable condition in a competitive manner, excessive competition about the details and conditions of coupons may occur, and a price collapse and a condition collapse (nullification) may occur.

When the user U1 visits the shop S1, the shop S1 is at full occupancy, and the user U1 may be introduced to the other shop OS1 similar to the shop S1 by the provision processing described above. However, when the user U1 has visited the shop S1 with the use of a coupon issues by the shop S1 as a precondition, the user U1 may show disapproval of a visit to the shop OS1 if the shop OS1 does not issue a coupon with similar details and conditions. When the shop S1 sets a 20% discount coupon, and when the coupon of the shop OS1 sets a 10% discount coupon, the user U1 may show disapproval of the use of the shop OS1, for example.

Given these circumstance, the information provision apparatus 10 executes the following coupon provision processing. First, the information provision apparatus 10 determines whether the user is in a comparison state that compares the shop S1 and the other shop OS competing with the shop S1 with each other. The information provision apparatus 10 provides the user with a certain coupon about the shop OS only when it is determined that the user is in the comparison state. In other words, the information provision apparatus 10 provides the user with a coupon dedicated to the time of comparison, or a coupon with a favorable condition that is not usually provided, for example, only when the user U1 is comparing shops competing with each other.

1-4. Outline of Privilege Provision Processing

It is considered that when users present around the shop S1 are introduced to the shop S1 or are provided with coupons of the shop S1, many users can be guided to the shop S1. However, among the users, there are some users who would reduce the profitability of the shop S1, such as a user who stays for a long time while ordering only one item. Consequently, the full occupancy of the shop S1 is prolonged, and a new user cannot use the shop S1, which may degrade profitability.

In the check-in service described above, abuse, that is, approaching the vicinity of the shop S1 and only acquiring an incentive despite of not actually using the shop S1 may occur. Such an unintended use, which only acquires visiting records or points by only checking in, is not favorable.

Given these circumstances, the information provision apparatus 10 executes the following privilege provision processing. First, the information provision apparatus 10 acquires a use starting date and time at which a user started the use of the shop S1 and a use ending date and time at which the user ended the use of the shop S1. The information provision apparatus 10 then provides the user with a certain privilege in accordance with a period from the acquired use starting date and time to the acquired use ending date and time (hereinafter, may be collectively referred to as a “using period”). When the using period falls within a certain time (“2 hours”, for example), the information provision apparatus 10 provides the user with various kinds of privileges beneficial for the user such as points, coupons, and discount services for example. For such privileges, not only privileges to be applied in the shop S1 that was used by the user, but also privileges with any details such as privileges that can be used at the other shop OS, various kinds of electronic online shopping malls, and the like can be employed.

2. Example of Functional Configuration and Working Effects of Information Provision Apparatus 10

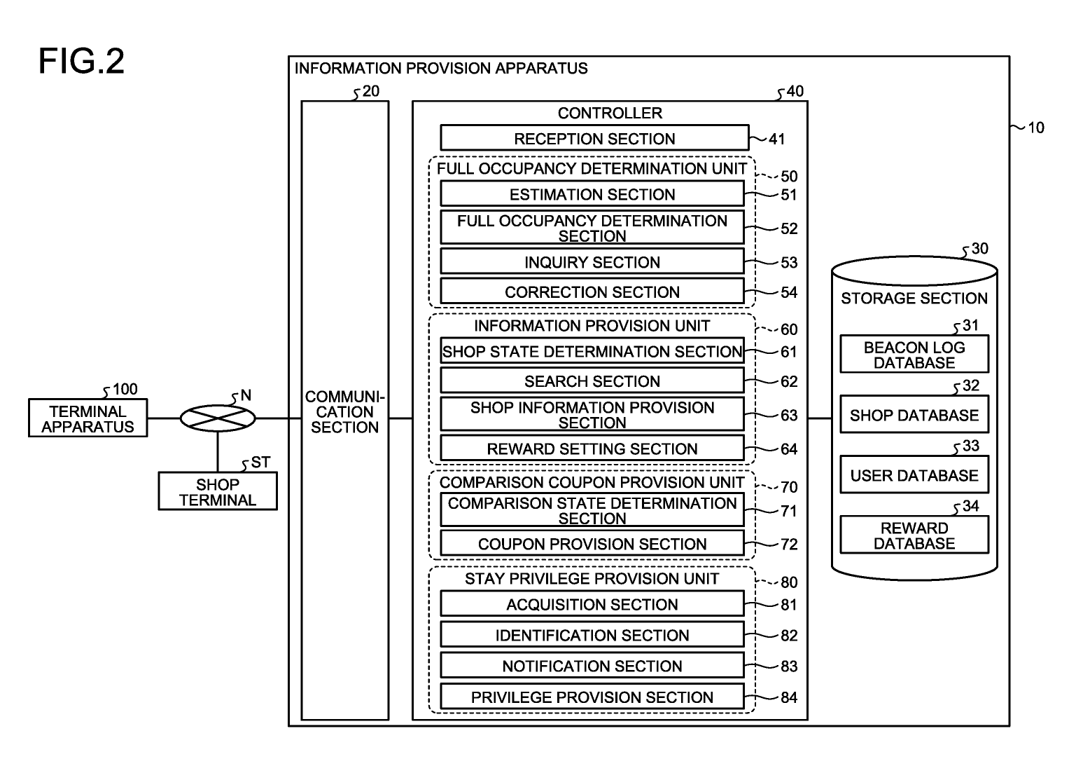

The following describes an example of a functional configuration and working effects of the information provision apparatus 10 that implements the provision processing, the determination processing, the coupon provision processing, and the privilege provision processing described above with reference to FIG. 2. Although the following description describes examples in which the information provision apparatus 10 executes the pieces of processing, embodiments are not limited to these examples. The working effects of the information provision apparatus 10 described below may be achieved by causing a provision server that executes the provision processing, a determination server that executes the determination processing, a coupon provision server that executes the coupon provision processing, and a privilege provision server that executes the privilege provision processing to cooperatively execute the pieces of processing, for example. In the following description, a “shop” may be read as a “facility”.

2-1. Example of Functional Configuration

FIG. 2 is a diagram for illustrating an example of the functional configuration of the information provision apparatus according to the embodiment. As illustrated in FIG. 2, the information provision apparatus 10 has a communication section 20, a storage section 30, and a controller 40. The communication section 20 is implemented by Network Interface Card (NIC), for example. The communication section 20 is connected to the network N in a wired or wireless manner and transmits and receives questions and responses to and from the terminal apparatus 100 and a shop terminal ST.

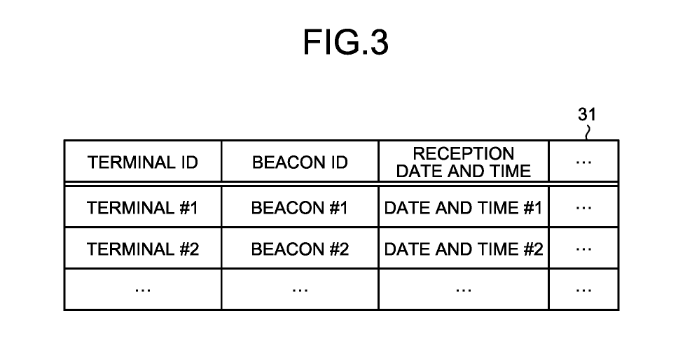

The storage section 30 is implemented by a semiconductor memory element such as a random access memory (RAM) or a flash memory or a storage apparatus such as a hard disk or an optical disc, for example. The storage section 30 has a beacon log database 31, a shop database 32, a user database 33, and a reward database 34. The following describes an example of information registered in the beacon log database 31, the shop database 32, the user database 33, and the reward database 34 (hereinafter, may be collectively referred to as “databases 31 to 34”) with reference to FIG. 3 to FIG. 6.

The history of information on reception notifications, or logs, are registered in the beacon log database 31. FIG. 3 is a diagram of an example of information registered in the beacon log database 31 according to the embodiment, for example. In the example illustrated in FIG. 3, pieces of information such as “terminal ID”, “beacon ID”, and “reception date and time” are registered in the beacon log database 31. Any information, if the information is various kinds of information indicated by the beacon signal or information on the terminal apparatus 100 that has received the beacon signal, may be registered in the beacon log database 31 apart from the information illustrated in FIG. 3.

“Terminal ID” is an identifier of the terminal apparatus 100 as a transmission source of reception notifications, that is, the terminal apparatus 100 that has received the beacon signal. “Beacon ID” is identification information indicated by the beacon signal received by the terminal apparatus indicated by associated “terminal ID”. “Reception date and time” is information indicating a date and time at which the terminal apparatus 100 indicated by associated “terminal ID” has received the beacon signal containing the identification information indicated by associated “beacon ID”.

In the example illustrated in FIG. 3, pieces of information such as the terminal ID “terminal #1”, the beacon ID “beacon #1”, and the reception date and time “date and time #1” are registered in the beacon log database 31 in association with each other, for example. Such pieces of information indicate that the terminal apparatus indicated by the terminal ID “terminal #1” has received the beacon signal containing the beacon ID “beacon #1” at the reception date and time “date and time #1”. Although the example illustrated in FIG. 3 describes conceptual values such as “terminal #1”, “beacon #1”, and “date and time #1”, in reality, numerical values and character strings for identifying the terminal apparatus and the beacon signal and numerical values, character strings, and the like for indicating the date and time are registered.

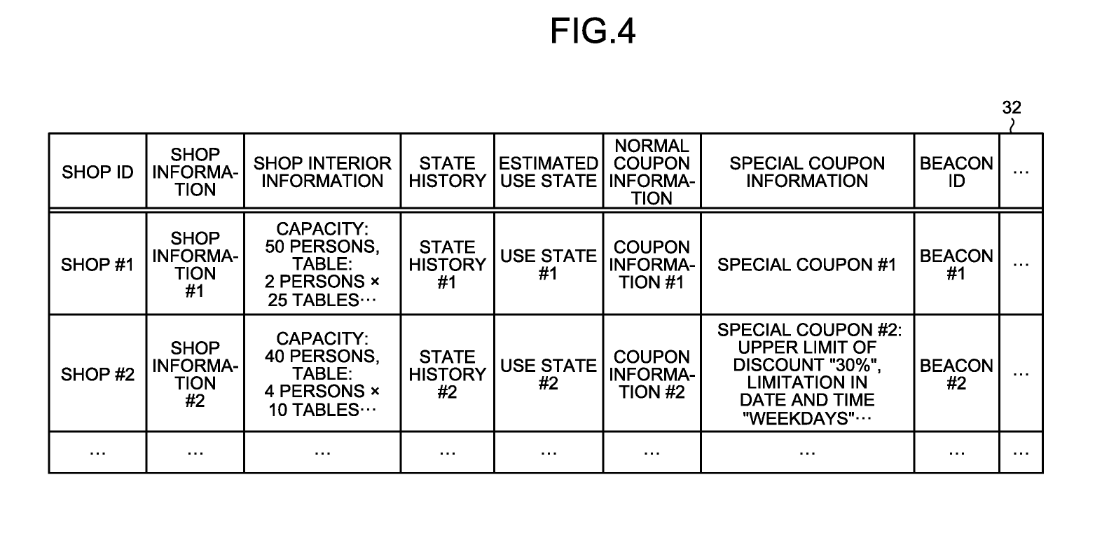

Various kinds of information on the shop S1 and the shop OS (hereinafter, may be collectively referred to as a “shop S”) are registered in the shop database 32. FIG. 4 is a diagram of an example of the pieces of information registered in the shop database according to the embodiment, for example. In the example illustrated in FIG. 4, “shop ID”, “shop information”, “shop interior information”, “state history”, “estimated using state”, “normal coupon information”, “special coupon information”, and “beacon ID” are registered in the shop database 32 in association with each other. Any information, if the information is information related to the shop S, may be registered in the shop database 32 apart from the information illustrated in FIG. 4.

“Shop ID” is information for identifying the shop S. “Shop information” is information on the shop S indicated by associated “shop ID” and is information indicating various kinds of attributions on the shop S such as the location of the shop S, the opening hours of the shop S, the type of the shop S such as a restaurant or an office, and the average price range of the shop S. “Shop interior information” is information on the interior of the shop S indicated by associated “shop ID” and is information on capacity, tables, seats, and the like.

“State history” is the history of information indicating the state of the shop S indicated by associated “shop ID” and is information such as the degree of congestion (a degree indicating congestion such as a seat occupancy rate, for example) or whether the shop S is at full occupancy. Such “state history” is acquired via the shop terminal ST installed in each shop S, for example. “Estimated using state” is information indicating the current state of the shop S estimated by the determination processing and is information such as the degree of congestion or whether the shop S is at full occupancy.

“Normal coupon information” is various kinds of information on a normal coupon, which is a coupon issued by the shop S indicated by associated “shop ID”, the coupon the information being opened to the user U1 all the time, which is the details and conditions of the coupon, for example. “Special coupon information” is various kinds of information on a coupon provided only when it is determined that the shop S indicated by associated “shop ID” is being compared with another shop, that is, a special coupon, which is the details and conditions of the special coupon, for example. When the conditions and details of the special coupon are automatically changed in accordance with the conditions and details of the normal coupon issued by the other shop S to be compared, the upper limit and the like of the details and conditions set as the special coupon are registered as “special coupon information”. “Beacon ID” is the beacon ID of the beacon signal transmitted by the transmission apparatus installed in the shop S indicated by associated “shop ID”.

In the example illustrated in FIG. 4, the shop ID “shop #1”, the shop information “shop information #1”, the shop interior information “capacity: 50 persons, table: 2 persons×25 tables, . . . ”, the state history “state history #1”, the estimated using state “using state #1”, the normal coupon information “coupon information #1”, the special coupon information “special coupon #1”, and the beacon ID “beacon #1” are registered in the shop database 32 in association with each other, for example. Such pieces of information indicate that information on the attribution of the shop S indicated by the shop ID “shop #1” is the shop information “shop information #1” and that the capacity is “50” persons, and “25” tables for “2” persons are installed as the shop interior information. Such pieces of information indicate that the state history acquired from the shop terminal ST of the shop S indicated by the shop ID “shop #1” is “state history #1” and that the estimated state of the shop is “using state #1”. Such pieces of information indicate that the shop S indicated by the shop ID “shop #1” issues the normal coupon indicated by the normal coupon information “coupon information #1”, that the shop S indicated by the shop ID “shop #1” issues “special coupon #1” as the special coupon when it is compared with the other shop S, and that the transmission apparatus that transmits the beacon signal containing the beacon ID “beacon #1” is installed.

Although the example illustrated in FIG. 4 describes conceptual values such as “shop #1”, “shop information #1”, “state history #1”, “using state #1”, “coupon information #1”, and “special coupon #1”, in reality, character strings and numerical values for identifying the shop, character strings indicating the attribution and the like of the shop, character strings indicating the state, and character strings and numerical values indicating the conditions and details of the coupon are registered in the shop database 32.

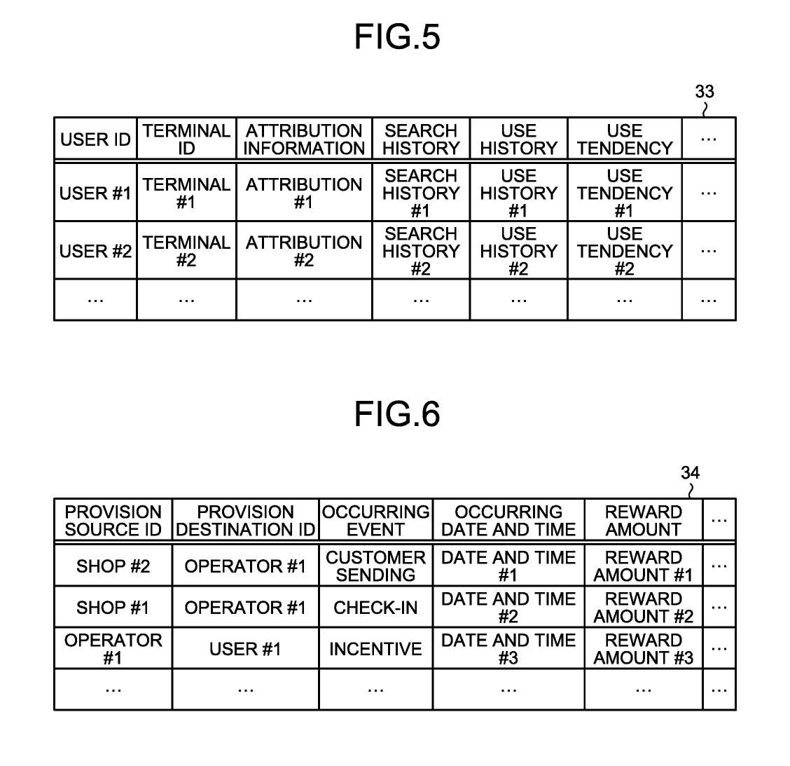

Various kinds of information on users are registered in the user database 33. FIG. 5 is a diagram of an example of the information registered in the user database according to the embodiment, for example. In the example illustrated in FIG. 5, “user ID”, “terminal ID”, “attribution information”, “search history”, “use history”, and “use tendency” are registered in the user database 33 in association with each other. Any information, if the information is information on users, may be registered in the user database 33 apart from the information illustrated in FIG. 5.

“User ID” is information for identifying the user. “Terminal ID” is a terminal ID of a terminal apparatus used by the user indicated by associated “user ID”. “Attribution information” is information indicating the attribution of the user such as demographic attribution or psychographic attribution of the user indicated by associated “user ID”. “Attribution information” may be information registered on the basis of input by the user and may be information estimated on the basis of the purchase history or the history of browsing web contents, the history of a search query, the position history, or the like of the user.

“Search history” is the history of web search by the user indicated by associated “user ID” and is the history of the search query, for example. “Use history” is the use history of each shop S by the user indicated by associated “user ID” and is information on a shop used, a date and time used, the amount of money used, the number of people using the shop S, and the like. “Use history” may be information collected on the basis of the history of a point-of-sales (POS) terminal installed in each shop S, credit card payment, web payment, or the like. “Use tendency” is the tendency of the use mode of the shop S by the user indicated by associated “user ID” and is information on the type of the shop S used by the user frequently, an average number of people using the shop S, an average amount of money used, and the like, for example.

In the example illustrated in FIG. 5, the user ID “user ID #1”, the terminal ID “terminal #1”, the attribution information “attribution #1”, the search history “search history #1”, the use history “use history #1”, and the use tendency “use tendency #1” are registered in the user database 33 in association with each other, for example. Such pieces of information indicate that the user indicated by the user ID “user #1” is using the terminal apparatus 100 indicated by the terminal ID “terminal #1” and has the attribution indicated by the attribution information “attribution #1”. Such pieces of information indicate that the history of the search query input by the user indicated by the user ID “user #1” is the search history “search history #1”, that the use mode of the shop S used is the use history “use history #1”, and that the tendency of the use mode when the shop S is used is the use tendency “use tendency #1”.

Although the example illustrated in FIG. 5 describes conceptual values such as “user #1”, “terminal #1”, “attribution #1”, “search history #1”, “use history #1”, and “use tendency #1”, in reality, character strings and numerical values for identifying the user and character strings and numerical values indicating the attribution, the search history, the use history, and the use tendency are registered in the user database 33.

Information on check-in at the shop S or a reward set with the guidance of the user U1 to another shop as an impetus is registered in the reward database 34. FIG. 6 is a diagram of an example of the information registered in the reward database according to the embodiment, for example. In the example illustrated in FIG. 6, pieces of information such as “provision source ID”, “provision destination ID”, “occurring event”, “occurring date and time”, and “reward amount” are registered in the reward database 34. Any information, if the information is information on the reward, may be registered in the reward database 34 apart from the information illustrated in FIG. 6.

“Provision source ID” is information indicating the provision source of the reward. “Provision destination ID” is information indicating the provision destination of the reward. Information indicating the shop ID of the shop S to be the provision source or the provision destination of the reward at the time of check-in or the operator of various kinds of services provided by the information provision apparatus 10 is registered in the reward database 34 as “provision source ID” or “provision destination ID”, for example. “Occurring event” is information indicating an event causing the occurrence of the reward; information such as “customer sending” indicating that a user who visited a shop S1 is introduced to another shop OS1, and the user U has checked in at the shop OS1, “check-in” indicating that the user U1 has checked in at the shop S, or “incentive” to be provided to the user who has checked in is registered, for example. “Occurring date and time” is information indicating a date and time at which an event indicated by associated “occurring event” occurred. “Reward amount” is information indicating a reward amount to be paid from the provision source indicated by associated “provision source ID” to the provision destination indicated by “provision destination ID”.

In the example illustrated in FIG. 6, the provision source ID “shop #2”, the provision destination ID “operator #1”, the occurring event “customer sending”, the occurring date and time “date and time #1”, and the reward amount “reward amount #1” are registered in association with each other, for example. Such pieces of information indicate that the reward amount indicated by the reward amount “reward amount #1”, the reward occurring on the ground of the event occurring at the date and time indicated by the occurring date and time “date and time #1”, the event being indicated by the occurring event “customer sending” is paid from the shop indicated by the provision source ID “shop #2” to the operator indicated by the provision destination ID “operator #1”. Although the example illustrated in FIG. 6 describes conceptual values such as “operator #1”, “date and time #1”, and “reward amount #1”, in reality, character strings identifying the operator, numerical values and character strings for identifying the date and time, and numerical values indicating the reward amount, and the like are registered.

Referring back to FIG. 2, the description thereof is continued. The controller 40 is a controller, for example, and is implemented by executing various kinds of computer programs stored in a storage apparatus within the information provision apparatus 10 with a storage area such as a RAM as a work area by a central processing unit (CPU), a micro processing unit (MPU), an application specific integrated circuit (ASIC), a field programmable gate array (FPGA), or the like. In the example illustrated in FIG. 2, the controller 40 has a reception section 41, a full occupancy determination unit 50, an information provision unit 60, a comparison coupon provision unit 70, and a stay privilege provision unit 80.

The full occupancy determination unit 50 has an estimation section 51, a full occupancy determination section 52, an inquiry section 53, and a correction section 54. The information provision unit 60 has a shop state determination section 61, a search section 62, a shop information provision section 63, and a reward setting section 64. The comparison coupon provision unit 70 has a comparison state determination section 71 and a coupon provision section 72. The stay privilege provision unit 80 has an acquisition section 81, an identification section 82, a notification section 83, and a privilege provision section 84.

The connection relation among the reception section 41, the estimation section 51, the full occupancy determination section 52, the inquiry section 53, the correction section 54, the shop state determination section 61, the search section 62, the shop information provision section 63, the reward setting section 64, the comparison state determination section 71, the coupon provision section 72, the acquisition section 81, the identification section 82, the notification section 83, and the privilege provision section 84 (hereinafter, may be referred to simply as “processing sections”) of the controller 40 is not limited to the connection relation illustrated in FIG. 2 and may be another connection relation. The processing sections implement and execute functions and actions of the pieces of processing as described below (FIG. 1, for example); these are functional units organized for description and do not necessarily correspond to actual hardware elements or software modules. In other words, so long as the functions and actions of the following selection processing and guidance processing can be implemented and executed, the information provision apparatus 10 may implement and execute the selection processing and the guidance processing by any functional unit.

2-2. Example of Working Effects of Processing Executed by Information Provision Apparatus

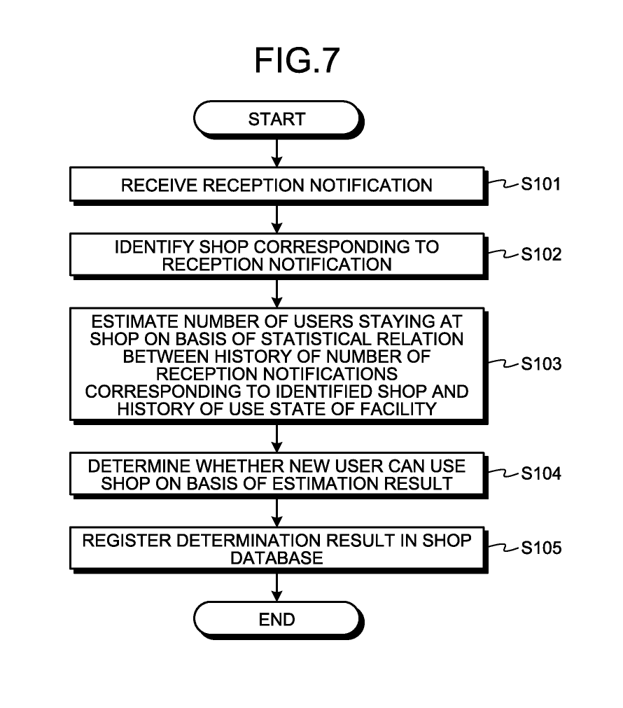

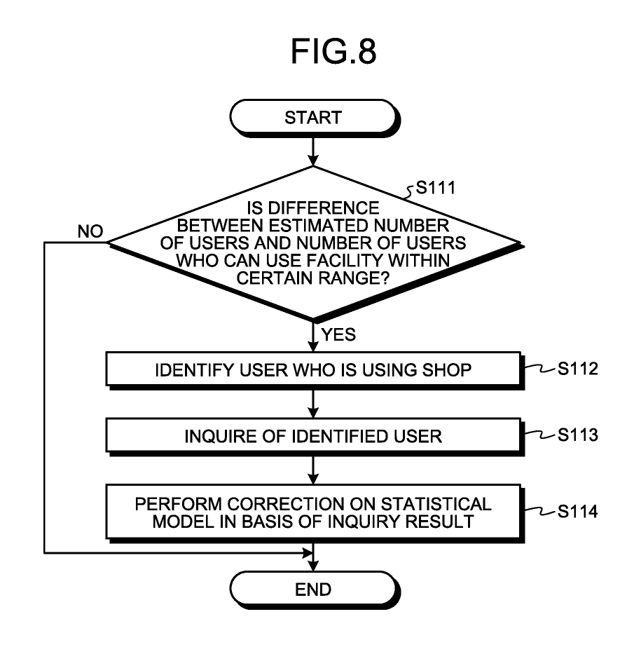

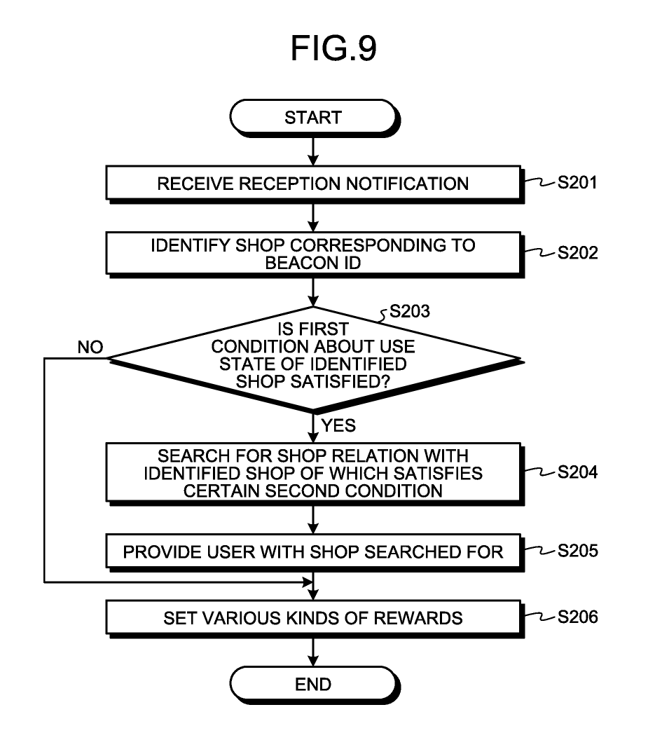

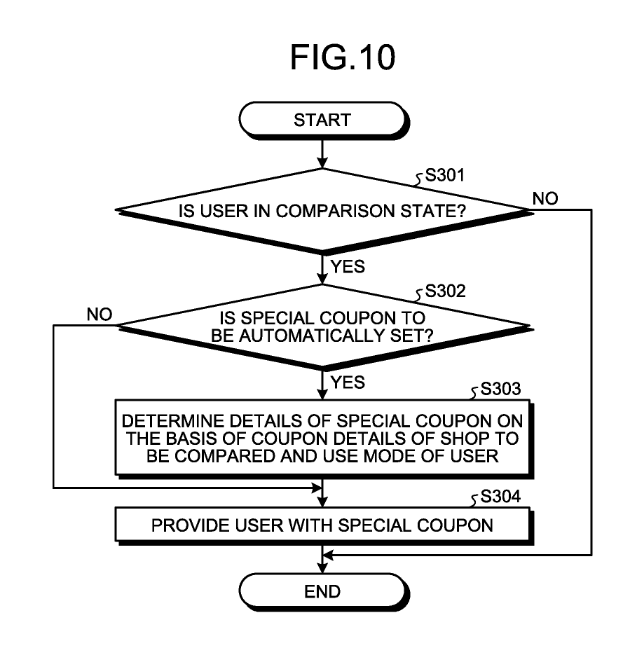

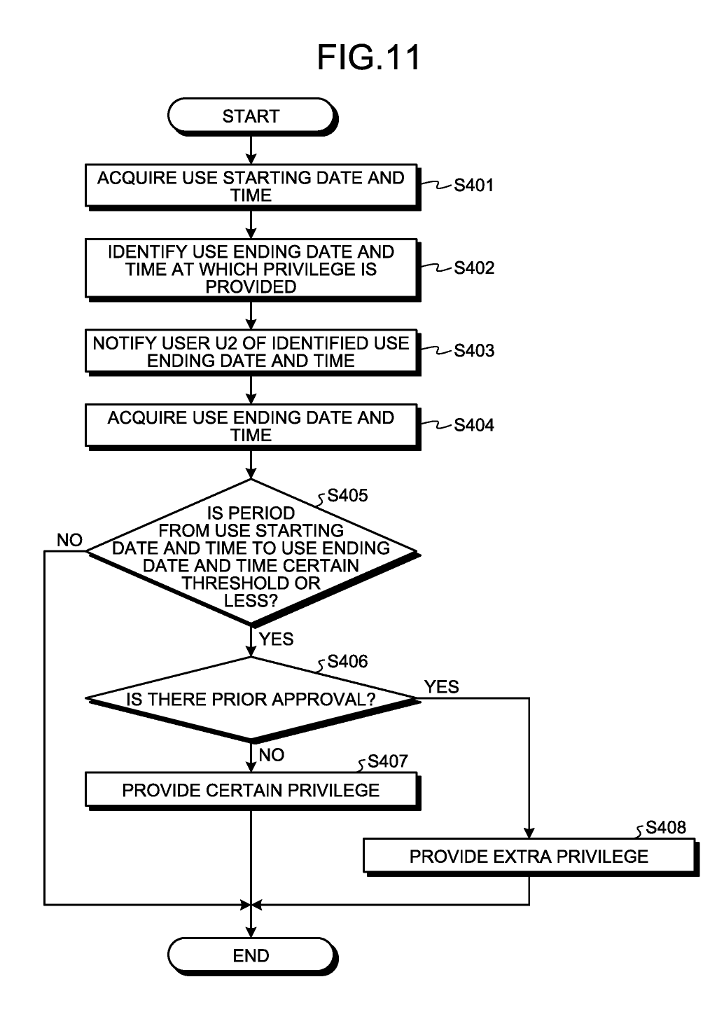

The following describes the details of the selection processing implemented and executed by the processing sections with reference to flowcharts illustrated in FIG. 7 to FIG. 11. FIG. 7 is a flowchart of an example of a procedure of the determination processing executed by the information provision apparatus according to the embodiment. FIG. 8 is a flowchart of an example of a procedure of processing to correct a statistical model for use in the determination processing by the information provision apparatus according to the embodiment. FIG. 9 is a flowchart of an example of a procedure of the provision processing executed by the information provision apparatus according to the embodiment. FIG. 10 is a flowchart of an example of a procedure of the coupon provision processing executed by the information provision apparatus according to the embodiment. FIG. 11 is a flowchart of an example of a procedure of the privilege provision processing executed by the information provision apparatus according to the embodiment.

2-3. Example of Working Effects in Determination Processing

The following first describes an example of the procedure of the determination processing with reference to FIG. 7. The reception section 41 receives a reception notification (Step S101), for example. In other words, from the terminal apparatus 100 having a notification function to output, when a user visits a certain facility, a notification that the user has visited the facility, the reception section 41 receives the notification. The reception section 41 receives a reception notification indicating the beacon ID corresponding to the shop S1 from the terminal apparatus 100 that has received the beacon ID corresponding to the shop S1, for example.

The reception section 41 further receives information indicating the using state of the certain facility from the shop terminal ST installed in the certain facility. The reception section 41 receives the number of people entered in the shop, bill details, the number of users staying at the shop, and the like at any time from the shop terminal ST such as a point-of-sales (POS) terminal installed in the shop S1, for example. The reception section 41 may receive information taken by an infrared camera or a monitoring camera installed in the shop S1 and identify the using state of the shop S1 (the number of people using the shop S1 or the degree of congestion, for example) on the basis of the received information, for example.

The estimation section 51 identifies a shop corresponding to the reception notification (Step S102). The estimation section 51 then estimates the number of users staying at the shop on the basis of a statistical relation between the history of the number of reception notifications corresponding to the identified shop and the history of the using state of the shop (Step S103). In other words, the estimation section 51 estimates the number of users who are visiting a certain facility from the number of reception notifications received in a certain period on the basis of the statistical relation between the history of the number of reception notifications and the history of the using state of the facility.

The estimation section 51 refers to the shop database 32 to identify the beacon ID corresponding to a shop for which a statistical model is generated (the shop S1, for example), for example. Subsequently, the estimation section 51 extracts reception notifications containing the identified beacon ID from the beacon log database 31. Subsequently, the estimation section 51 reads the state history and the shop interior information of the shop S1 from the shop database 32 and generates a statistical model corresponding to the shop S1 on the basis of the number of the extracted reception notifications, the state history, and the shop interior information. The estimation section 51 estimates the number of users in each past time zone on the basis of the degree of congestion indicated by the state history and information on the capacity and tables indicated by the shop interior information, for example. Subsequently, the estimation section 51 generates an estimation model for estimating the number of users who are using the shop S1 from the number of reception notifications received in a certain time on the basis of the ratio between the estimated number of users and the number of reception notifications received in each time zone. For such an estimation model, any model such as a multiple regression model can be employed.

Subsequently, the estimation section 51 counts the number of reception notifications indicating the beacon ID corresponding to the shop S1 among the reception notifications received within a certain period from the time of processing (the past one hour, for example). The estimation section 51 then estimates the number of users who are using the shop S1 at the time of processing using the counted number and the statistical model. In other words, the estimation section 51 estimates the number of users who are visiting the certain facility on the basis of the ratio between the number of notifications received in a certain time zone and the number of users who used a certain facility in the certain time zone. In other words, the estimation section 51, with the terminal apparatus 100 having the notification function as a probe, estimates the number of users who are actually using the shop S1 on the basis of the number of probes that visited the shop S1.

The full occupancy determination section 52 determines whether a new user can use the shop S1 on the basis of an estimation result by the estimation section 51 (Step S104). More specifically, the full occupancy determination section 52 determines whether a new user can use the certain facility on the basis of a comparison result between the number of users estimated by the estimation section 51 and the number of users who can use the certain facility. The full occupancy determination section 52 compares the number of users of the shop S1 estimated by the estimation section 51 and the number of users who can use the shop S1 registered as the shop interior information (that is, “capacity”) with each other, for example. When the number of users of the shop S1 estimated by the estimation section 51 exceeds the number of users who can use the shop S1 registered as the shop interior information, the full occupancy determination section 52 determines that the shop S1 is at full occupancy.

When the ratio of the number of users estimated by the estimation section 51 to the number of users who can use the shop S1 exceeds a certain ratio (80%, for example), the full occupancy determination section 52 may determine that the shop S1 is at full occupancy, for example. The full occupancy determination section 52 may calculate the ratio of the number of users estimated by the estimation section 51 to the number of users who can use the shop S1 as the degree of congestion. The full occupancy determination section 52 then registers a determination result in the shop database 32 as an estimated using state (Step S105).

The following describes an example of the procedure of the determination processing with reference to FIG. 1. As illustrated in FIG. 1, when the terminal apparatus 100 receives a beacon signal transmitted by the transmission apparatus B1, the information provision apparatus 10 receives a reception notification containing a beacon ID indicated by the beacon signal transmitted by the transmission apparatus B1 (Step S1), for example. The information provision apparatus 10 acquires a use mode in the shop OS (the number of users who have been using the shop OS, for example) from the POS terminal, the shop terminal ST installed in the shop, or the like (Step S2) and acquires the use mode of the shop from the shop S1 (Step S3).

In such a case, the information provision apparatus 10 identifies the number of people using the shop S1 at a certain date and time from the acquired use history of each shop S and counts the number of reception notifications indicating the beacon ID corresponding to the shop S1 among the reception notifications received at the certain date and time. The information provision apparatus 10 then generates a statistical model based on the ratio between the number of reception notifications and the actual number of people using the shop (Step S4). The information provision apparatus 10 may generate a statistical model based on the ratio between the value of the degree of congestion and the number of reception notifications, for example.

The information provision apparatus 10 then determines whether the shop is at full occupancy using the statistical model and registers a determination result (Step S5). The information provision apparatus 10 estimates the number of all users who are using the shop S1 using the statistical model from the number of reception notifications indicating the beacon ID corresponding to the shop S1 among the reception notifications received within a certain period (the past one hour, for example), for example. The information provision apparatus 10 then compares the estimated number of users and the number of users who can use the shop S1 with each other and determines whether the shop S1 is at full occupancy on the basis of a comparison result. After that, the information provision apparatus 10 registers a determination result in the shop database 32 as a state history.

In other words, the information provision apparatus 10 estimates the number of users including users who use the terminal apparatus 100 that does not have the notification function from the number of customers who have checked in using the terminal apparatus 100 that has the notification function among the users staying at the shop S1 and determines whether the shop S1 is at full occupancy on the basis of an estimation result. In other words, the information provision apparatus 10 estimates whether the shop S1 is at full occupancy from the number of customers who have checked in. More specifically, the information provision apparatus 10 estimates a fullness/vacancy state from a fullness/vacancy state obtained from the shop terminal ST or the like and the statistics of the ratio between the number of seats of the shop and the number of users who have checked in.

2-4. Example of Working Effects in Processing to Correct Statistical Model

The following describes an example of the procedure of the processing to correct the statistical model for use in the determination processing with reference to FIG. 8. The inquiry section 53 determines whether the difference between the estimated number of users and the number of users who can use the shop S1 is within a certain range (Step S111). In other words, when the relation between the number of users estimated by the estimation section 51 and the number of users who can use the certain facility satisfies a certain condition, the inquiry section 53 inquires about the using state of the certain facility.

If the difference between the estimated number of users and the number of users who can use the shop S1 is within the certain range (Yes at Step S111), the inquiry section 53 identifies a user who is using the shop S1 (Step S112) and inquires of the identified user (Step S113). The inquiry section 53 searches the beacon log database 31 for the terminal apparatus 100 serving as an output source of the reception notification indicating the beacon ID corresponding to the shop S1 to be processed, for example. More specifically, the inquiry section 53 identifies the terminal apparatus 100 serving as an output source of a reception notification with the latest reception date and time among the reception notifications indicating the beacon ID corresponding to the shop S1. The inquiry section 53 then inquires of the identified terminal apparatus 100 about the using state of the shop S1.

When inquiring about the using state of the shop S1, the inquiry section 53 may make inquiry about any details. The inquiry section 53 may inquire about whether the shop S1 is at full occupancy, whether the shop S1 is congested, whether a new user can use the shop S1, or the like, for example. Such an inquiry may cause the terminal apparatus 100 to display buttons for performing stepwise responses such as “being at full occupancy”, “being congested”, and “not being congested” in order to easily obtain a response by a user as an inquiry destination.

When the terminal apparatus 100 serving as the output source of the notification contributes certain information to a network, the inquiry section 53 may inquire about the using state of the certain facility, for example. When the terminal apparatus 100 contributes various things to a social networking service (SNS) or the like, it is estimated that the user is using the terminal apparatus 100 while holding it, for example. Given these circumstances, the inquiry section 53 may inquire about the congestion state of the shop S1 with the fact that the terminal apparatus 100 has contributed various things such as pictures and sentences to the SNS as an impetus. In contrast, if the difference between the estimated number of users and the number of users who can use the shop S1 is not within the certain range (No at Step S111), the inquiry section 53 then ends the processing.

The correction section 54 performs correction on the statistical model on the basis of an inquiry result (Step S114). In other words, the correction section 54 corrects the statistical relation between the history of the number of reception notifications and the history of the using state of the facility, that is, the statistical model on the basis of the inquiry result by the inquiry section 53. Consequently, the estimation section 51 estimates the number of users who are visiting the certain facility on the basis of the relation corrected by the correction section 54.

When a certain number of reception notifications are received, and when a response that the shop S1 is not congested is obtained as a result of the inquiry even though the number of people estimated by the estimation section 51 exceeds the number of people that can use the shop S1, the correction section 54 corrects the statistical model so as to reduce the number of users estimated when the number of reception notifications are received, for example. When a certain number of reception notifications are received, and when a response that the shop S1 is at full occupancy is obtained as a result of the inquiry even though the number of people estimated by the estimation section 51 is less than the number of people that can use the shop S1, the correction section 54 corrects the statistical model so as to increase the number of users estimated when the number of reception notifications are received.

In other words, the information provision apparatus 10 inquires of a visitor who has checked in at the shop S1 about its fullness/vacancy state and obtains the fullness/vacancy state through a inquiry result. The information provision apparatus 10 corrects a statistical result by the relation between a determination result and the inquiry result.

2-5. Example of Working Effects in Provision Processing

The following describes an example of the procedure of the provision processing with reference to FIG. 9. The reception section 41 receives a reception notification (Step S201). In other words, the reception section 41 receives a notification that a signal transmitted by a certain transmission apparatus installed in the first facility has been received from the terminal apparatus 100 used by a user.

The shop state determination section 61 identifies the shop S1 corresponding to the beacon ID indicated by the reception notification (Step S202). The shop state determination section 61 determines whether the first condition about the using state of the identified shop S1 is satisfied (Step S203). In other words, the shop state determination section 61 determines whether the first condition is satisfied on the basis of the received notification. The shop state determination section 61 refers to the shop database 32 for the estimated using state of the shop S1 corresponding to the beacon ID and determines whether the shop S1 is at full occupancy as the first condition, for example.

The shop state determination section 61 may determine whether any condition is satisfied so long as it is a condition about the using state of the shop corresponding to the beacon ID. The shop state determination section 61 may determine whether a time estimated to be required until the shop S1 corresponding to the beacon ID becomes able to be used exceeds a certain threshold as the first condition, for example. More specifically, when the estimated using state of the shop S1 indicates full occupancy, the shop state determination section 61 estimates a time until the shop S1 has vacancies on the basis of the state history. For such estimation, various kinds of methods of estimation can be employed. When the estimated time exceeds a certain threshold (15 minutes, for example), the shop state determination section 61 may determine that the first condition is satisfied.

The shop state determination section 61 may estimate the time until the shop S1 has vacancies on the basis of changes in the degree of congestion registered as using state #1,an average staying time per user, or the like. Such a staying time may be calculated on the basis of the average of a time duration from a time at which the beacon signal of the shop S1 becomes to be received to a time at which it becomes not to be received or the like or calculated on the basis of information obtained from the shop terminal ST (a time from entry to bill payment, for example) or the like, for example. The time estimated to be required until the shop S1 becomes able to be used may be estimated on the basis of a time elapsed from a date and time at which each terminal apparatus 100 received the beacon signal of the shop S1, for example.

The shop state determination section 61 may estimate the number of users who are using the shop S1 as users and determine whether there are vacancies that can be used by the estimated number of users as the first condition. The shop state determination section 61 refers to the user database 33 and estimates an average number of people when the user of the terminal apparatus 100 as the transmission source of the reception notification uses the shop, for example. Such a number of people may be estimated on the basis of a value obtained by dividing an amount of money used at the shop S visited by the user in the past by an average amount of money used in the shop S, for example. The shop state determination section 61 may determine whether there are vacancies that can be used by the estimated number of users from the shop information and the estimated using state and, when there are not such vacancies, determine that the first condition is satisfied.

The shop state determination section 61 may determine whether the first condition is satisfied on the basis of the number of reception notifications received in a certain period before receiving a reception notification. When receiving a reception notification indicating the beacon ID of the shop S1 from the terminal apparatus 100 of the user U1, the shop state determination section 61 counts the number of reception notifications received in the past one hour, the reception notifications indicating the beacon ID of the shop S1, for example. When the counted number of reception notifications exceeds the capacity of the shop S1, the shop state determination section 61 may estimate that the shop S1 is at full occupancy and determine that the first condition is satisfied.

In other words, the shop state determination section 61 may determine whether the user of the terminal apparatus 100 as the transmission source of the reception notification can immediately use the shop S1 and, when it is determined that the user cannot immediately use the shop S1, determine that the first condition is satisfied.

If it is determined that the first condition is satisfied (Yes at Step S203), the search section 62 searches for a shop the relation with the identified shop S1 of which satisfies the certain second condition (Step S204). The search section 62 searches for a shop common to the shop S1 corresponding to the beacon ID indicated by the reception notification in shop kind or type or the shop OS the distance from the shop S1 of which falls within a certain range as the shop that satisfies the second condition, for example. In other words, the search section 62 searches for the other shop OS similar to the shop S1.

When it is determined that the first condition is satisfied for the shop S1, the search section 62 reads the shop information of the shop S1 from the shop database 32, for example. The search section 62 then compares the read shop information with another shop information and searches for another shop located within a certain range (a radius of 100 meters, for example) of the shop S1, the other shop being the same as or similar to the shop S1 in shop type (the shop OS1, for example).

The search section 62 may search for any shop that satisfies the second condition so long as it is at least a shop located within a certain range from the shop S1. The search section 62 may search for a shop similar to the shop S1 in any information related to the shop such as the type of foods and drinks provided, a genre, a price range, an average staying time of users, opening hours, the details of issued coupons, whether entry with one's children is allowed, whether carrying-in is allowed, and attractions registered in advance by the shop as the shop that satisfies the second condition, for example. The search section 62 may calculate a similarity score indicating the degree of similarity between the shop S1 and the shop OS1 with these pieces of information as elements and, when the calculated score exceeds a certain threshold, determine that the shop S1 and the shop OS1 are similar to each other. In other words, the search section 62 may search for any shop so long as it is a shop that satisfies the first condition, that is, a shop similar to a shop that cannot be immediately used by the user U1 or a shop that competes therewith.

The search section 62 may search for a shop that can be immediately used by the user U1 as the second condition. The search section 62 may search for a shop of the same type (“Italian restaurant”, for example) as the shop S1, the shop being located within a certain range from the shop S1 and the using state registered in the shop database 32 of which being not at full occupancy, for example. The search section 62 may search for a shop that matches the taste of the user U1. The search section 62 may search for a shop similar in type to shops frequently used by the user U1 on the basis of the various kinds of attributions of the user U1, for example.

The shop information provision section 63 provides the user with the shop OS1 searched for (Step S205). The shop information provision section 63 distributes the name, the telephone number, the details and pictures of foods and drinks to be provided, the price range, the location, and the like of the shop OS1 to the terminal apparatus 100 of the user U1, for example. The shop information provision section 63 may distribute contents for reserving the shop OS1 together with the information on the shop OS1. In contrast, if it is determined that the first condition about the using state of the identified shop S1 is not satisfied (No at Step S203), the shop state determination section 61 does not perform searching for the shop that satisfies the second condition and the like.

Subsequently, the reward setting section 64 sets various kinds of rewards (Step S206). When the user U1 visits the shop S1, the reward setting section 64 sets a certain reward amount for the operator from the shop S1 and registers various kinds of information in the reward database 34 such that the certain reward amount will be paid from the operator to the user with the reward amount as fund, for example. When an advertisement for the shop S1 is being distributed to the user U1, and when the user U1 visits the shop S1 and performs a certain check-in operation, the reward setting section 64 sets a certain reward amount for the operator from the shop S1 and sets a reward amount for the user from the operator, for example.

When the user U1 who has visited the shop S1 is provided with the information on the shop OS1, and when the user U1 visits the shop OS1 (that is, when the user U1 visits the shop OS1 as the second facility), the reward setting section 64 sets a certain reward amount for the shop O1 from the shop OS1. When a check-in operation at the shop OS1 is performed (that is, when the user U1 actually visits the other recommended shop), the reward setting section 64 sets a certain reward amount for the shop O1 from the shop OS1, for example. In other words, the reward setting section 64 sets an affiliate fee from the second facility as a customer sending destination for the first facility as a customer sending source as a compensation for opportunity loss and the like.

The following describes an example of the procedure of the provision processing with reference to FIG. 1. In the example illustrated in FIG. 1, the information provision apparatus 10 receives a reception notification from the terminal apparatus 100 (Step S6), for example. In such a case, the information provision apparatus 10 determines that the user U1 has visited the shop S1 from the beacon ID indicated by the reception notification and refers to the latest state history associated with the shop S1. The information provision apparatus 10 then determines whether the shop S1 is at full occupancy.

Subsequently, when it is determined that the shop S1 is at full occupancy, the information provision apparatus 10 searches for a shop that is located close to the shop S1 and is similar to the shop S1 in type and identifies the shop OS1, which is an Italian restaurant being the same as the shop S1 (Step S7), for example. The information provision apparatus 10 then provides the terminal apparatus 100 with the information on the identified shop OS (Step S8).

In other words, the information provision apparatus 10 determines the vacancy state of the shop S1 through check-in by the beacon signal and, when the shop S1 is at full occupancy, guides the user U1 to the other shop OS1, which is similar to the shop S1. When the shop S1 is at full occupancy and cannot be checked in, the information provision apparatus 10 recommends a shop that is close to the shop S1, has a vacancy, and meets the condition of the user U1 instead, for example. Thus, the information provision apparatus 10 visualizes the vacancy information of shops and user attribution using the beacon, matches the pieces of data to each other in real time, guides a user from a fully occupied shop to a shop having vacancies, and can thereby improve a conversion (e.g. success-to-visit) rate. In addition, the information provision apparatus 10 determines the number of customers in shops through check-in using the beacon and can digitize the vacancy stock information of each shop S in real time.

Even when the first facility (the shop S1, for example) visited by the user U1 is at full occupancy, the information provision apparatus 10 can provide the user U1 with the information on the second facility (the shop OS1, for example) similar to the first facility, that is, a second shop estimated to be liked by the user and can thus cause the user to immediately enter the favorite facility. The information provision apparatus 10 can provide the user U1 with a check-in point even when the first facility is at full occupancy. The information provision apparatus 10 sends the user who visited the first facility at full occupancy to the second facility and thereby causes the second facility to provide the first facility with affiliate. Consequently, the first facility can prevent simple opportunity loss. The second facility can fill its vacancy. The operator of the information provision apparatus 10 can improve the satisfaction level of the user U1, improve the satisfaction level of facilities receiving the provision of services by the various kinds of processing, and achieve affiliate income and efficient elimination of vacancies. The operator can achieve an increase in cost per acquisition (CPA) caused by an decrease in the number of check-in.

2-6. Example of Working Effects in Coupon Providing Processing

The following describes an example of the procedure of the coupon provision processing with reference to FIG. 10. The comparison state determination section 71 determines whether the user U1 is in a certain comparison state (Step S301). More specifically, the comparison state determination section 71 determines whether the user U1 is in a comparison state that compares a certain facility with another facility that competes with the certain facility. When the user visits the shop S1, and when the shop S1 is at full occupancy and cannot thus be used, the comparison state determination section 71 determines that the user U1 is in the comparison state, for example.

As a more specific example, the comparison state determination section 71 identifies the shop S visited by the user U1 using the beacon ID indicated by the reception notification received from the terminal apparatus 100 of the user U1. In other words, when receiving the reception notification from the terminal apparatus 100 used by the user U1, the comparison state determination section 71 determines that the user U1 has visited a certain shop S corresponding to the beacon ID indicated by the reception notification.

When the shop S is at full occupancy and cannot thus be used, it is estimated that a state whether the user U1 waits for a vacancy occurring in the shop S or moves to another shop, that is, the comparison state that compares a plurality of shops with each other is occurring. When the provision processing described above is performed, it is estimated that the user U1 has been provided with the information on the shop OS1, and that the comparison state that compares the shop S and the shop OS1 with each other is occurring. Given these circumstance, the comparison state determination section 71 estimates that when the shop S visited by the user U1 is at full occupancy and cannot thus be used, the user U1 is in the comparison state.

The coupon provision section 72 provides the user U1 with a certain coupon about the certain facility, that is, the special coupon only when it is determined that the user U1 is in the comparison state. When the user U1 is in the comparison state that compares the shop S1 visited by the user U1 and the other shop OS1 with each other, the coupon provision section 72 provides the user U1 with the special coupon of the shop OS1 to be compared, for example. In other words, the coupon provision section 72 distributes the special coupon that is not distributed at normal times but provided only when the shop OS1 is compared with the other competing shop S1.

If it is determined by the comparison state determination section 71 that the user U1 is in the comparison state between the shop S1 and the shop OS1 (Yes at Step S301), the coupon provision section 72 determines whether the special coupon of the shop OS1 is to be automatically set (Step S302). If it is determined that the special coupon of the shop OS1 is to be automatically set (Yes at Step S302), the coupon provision section 72 determines the details of the special coupon on the basis of the coupon details of the coupon of the shop S1 to be compared and the use mode of the user U1 (Step S303).

The coupon provision section 72 provides the user U1 with a coupon as the special coupon with a more favorable condition than that of the coupon provided to the user U1 by the shop S1, for example. As a more specific example, when the normal coupon of the shop S1 is a “10% discount” coupon, the coupon provision section 72 sets a “20% discount” coupon as the special coupon of the shop OS1. The coupon provision section 72 may set a coupon with a looser use condition than that of the normal coupon of the shop S1 or the like, for example. When the normal coupon of the shop S1 can be used only on Saturdays and Sundays, the coupon provision section 72 may set the special coupon that can be used regardless of the day of the week as the coupon of the shop OS1, for example. The coupon provision section 72 may set the special coupon with the same details as those of the coupon provided to the user U1 by the shop S1. In other words, the coupon provision section 72 sets a coupon as the special coupon with details corresponding to the details of the coupon provided to the user U1 by the shop S1 to be compared with the shop OS1.

The coupon provision section 72 may set the details of the special coupon not on the basis of the coupon set by the shop S1 as the normal coupon but on the basis of the details of a coupon acquired by the user U1 with the intention of using it among the coupons set by the shop S1. In other words, the coupon provision section 72 may provide the user U1 with a coupon as the special coupon with details corresponding to the details of a coupon that has been provided to the user U1 by the shop S1. The coupon provision section 72 may set the special coupon with any details within a range from the upper limit of a discount rate and conditions registered as the special coupon information by the shop OS1. In other words, the coupon provision section 72 provides the user U1 with a special coupon as the special coupon with details automatically set within a range set in advance by the shop OS1.

The coupon provision section 72 provides the user U1 with the special coupon (Step S304). In contrast, if it is determined that the special coupon is not to be automatically set (No at Step S302), the coupon provision section 72 provides the user U1 with the registered special coupon (Step S304) and ends the processing. If it is determined that the user U1 is not in the comparison state (No at Step S301), the coupon provision section 72 then ends the processing without providing the user U1 with the special coupon.

The following describes an example of the procedure of the coupon provision processing with reference to FIG. 1. The information provision apparatus 10 receives a reception notification (Step S9), for example. In such a case, the information provision apparatus 10 determines that the user U1 has visited the shop S1 from the beacon ID indicated by the reception notification and determines whether the shop S1 is in a comparison state with another shop (Step S10). The information provision apparatus 10 refers to the latest state history associated with the shop S1, for example. The information provision apparatus 10 determines whether the shop S1 is at full occupancy.

When the shop S1 is at full occupancy, it can be estimated that the user U1 is in the comparison state that compares the shop S1 and the shop OS1 with each other. Given these circumstances, when the shop S1 is at full occupancy, and when the user U1 is provided with the information on the shop OS1, the information provision apparatus 10 identifies the special coupon set by the shop OS1. The information provision apparatus 10 then provides the user U1 with the special coupon of the shop OS1 (Step S11).

In other words, the information provision apparatus 10 provides the user U1 with a real-time competition coupon as the special coupon provided only when the shops compete with each other in real time. The information provision apparatus 10 provides the user U1 with a coupon with the same condition as or a more favorable condition than that of a shop to be compared automatically on the basis of setting.

2-7. Example of Working Effects in Privilege Provision Processing

The following describes an example of the procedure of the privilege provision processing with reference to FIG. 11. The acquisition section 81 acquires a use starting date and time at which a user U2 started the use of the shop S1 and a use ending date and time at which the user U2 ended the use of the shop S1, for example. The acquisition section 81 acquires the use starting date and time (Step S401), for example. As a more specific example, the acquisition section 81 acquires a date and time at which a reception notification that the beacon signal transmitted by the certain transmission apparatus B1 installed in the shop S1 was received from the terminal apparatus 100 used by the user U2 as the use starting date and time. When thus identifying the use starting date and time using the beacon signal, the acquisition section 81 may identify the use starting date and time using the information registered in the beacon log database 31.

When identifying that the user U2 has visited the shop S1 using the beacon signal, the acquisition section 81 causes the terminal apparatuses 100 to display a timer and display a message that prompts a clerk to perform a starting operation on the timer, for example. The acquisition section 81 may set a date and time at which the clerk of the shop S1 performed the staring operation on the timer as the use starting date and time.

Subsequently, the identification section 82 identifies a use ending date and time at which a privilege can be provided (Step S402). More specifically, the identification section 82 identifies a use ending date and time at which a certain privilege is provided on the basis of the acquired use starting date and time. When the user U2 is provided with a certain point when the using period in the shop S1 by the user U2 is 2 hours or shorter, the identification section 82 identifies a date and time 2 hours after the use starting date and time as the use ending date and time at which a privilege can be provided, for example.

Subsequently, the notification section 83 notifies the user U2 of the use ending date and time identified by the identification section 82 (Step S403). The notification section 83 causes the terminal apparatus 100 of the user U2 to display the use ending date and time identified by the identification section 82 and display a button to acknowledge leaving by the date and time in advance and a button not to acknowledge it, for example. When the user U2 selects the button to acknowledge leaving by the use ending date and time in advance, the notification section 83 determines that the user U2 has acknowledged leaving by the use ending date and time in advance.

Subsequently, the acquisition section 81 acquires the use ending date and time (Step S404). The acquisition section 81 may acquire a date and time at which the terminal apparatus 100 of the user U2 becomes not to receive the beacon signal of the shop S1 as the use ending date and time, for example. When receiving a notification of a date and time at which the user U2 paid the bill or a notification of a date and time at which the user U2 left the shop S1 from the shop terminal ST installed in the shop S1, the acquisition section 81 may acquire the date and time as the use ending date and time, for example. In other words, the acquisition section 81 may acquire the use starting date and time and the use ending date and time using any method so long as it acquires a date and time at which the user U2 started the use of the shop S1 as the use starting date and time and acquires a date and time at which the user U ended the use of the shop S1 as the use ending date and time.

The privilege provision section 84 provides the user U2 with a certain privilege in accordance with the using period, which is a period from the use starting date and time to the use ending date and time. The privilege provision section 84 determines whether the using period from the use starting date and time to the use ending date and time is a certain threshold or shorter (Step S405), for example. If it is determined that the using period is the threshold or shorter (Yes at Step S405), the privilege provision section 84 determines whether there is prior approval for a notification (Step S406). If there is no prior approval (No at Step S406), the privilege provision section 84 provides the user U2 with the certain privilege (Step S407). In contrast, if there is prior approval (Yes at Step S406), the privilege provision section 84 provides the user U2 with an extra privilege, the privilege details of which are increased than the certain privilege (Step S408).

In other words, if the using period is the certain threshold or shorter, the privilege provision section 84 provides the user U2 with the privilege. When the user U2 approves the end of the use of the shop S1 at the use ending date and time notified of by the notification section 83 and ends the use of the shop S1 by the use ending date and time, the privilege provision section 84 provides the user U2 with an additional privilege together with the certain privilege. In contrast, if it is determined that the using period exceeds the certain threshold (No at Step S405), the privilege provision section 84 ends the processing without providing the user U2 with any privilege.

The following describes an example of the procedure of the privilege provision processing with reference to FIG. 1. The information provision apparatus 10 acquires the use starting date and time of the user U2 who is using the shop S1 (Step S12), for example. The information provision apparatus 10 calculates a use ending date and time at which a privilege is provided (Step S13). The information provision apparatus 10 notifies the user U2 of the calculated use ending date and time at which a privilege is provided (Step S14).

The information provision apparatus 10 acquires the use ending date and time of the user U2 (Step S15). The information provision apparatus 10 acquires a date and time at which the user U2 leaves the shop S1 as indicated by OT in FIG. 1, and the terminal apparatus 100 of the user U2 becomes not to receive the beacon signal of the beacon ID corresponding to the shop S1 as the use ending date and time, for example. The information provision apparatus 10 calculates the using period from the use starting date and time and the use ending date and time acquired and determines whether the calculated using period satisfies a certain condition (Step S16). The information provision apparatus 10 determines whether the using period is within 2 hours, for example. When the using period satisfies the certain condition, the information provision apparatus 10 provides the user U2 with the certain privilege (Step S17).

As described above, the information provision apparatus 10 provides a privilege corresponding to an entry time and a leaving time. In other words, the information provision apparatus 10 provides a user with a leaving timing coupon corresponding to leaving timing. As a result of such processing, the information provision apparatus 10 can return business effects corresponding to the use scale, the staying time, and the like of the shop S1 to users and facilitate users desired by the shop S1 to visit the shop S1.

The information provision apparatus 10 receives from the user U2 in advance an operation to express an intention to leave the shop S1 at the use ending date and time at which a privilege is provided. On top of that, when the user U2 actually leaves the shop S1 by the use ending date and time notified of, the information provision apparatus 10 provides the extra privilege. Thus, the information provision apparatus 10 receives the prior approval or provides the user U2 with the privilege according to the using period and can thereby estimate future vacancy stock (eight vacancies one hour later, for example) and achieve reservation reception according to an estimation result.

3. Modifications

The information provision apparatus 10 according to the embodiment described above may be performed in various different modes other than the embodiment. The following describes other embodiments of the information provision apparatus 10.

3-1. About Modification of Determination Processing

The following first describes various modifications of the determination processing described above.

3-1-1. About Unit of Statistical Model

In the above description, the information provision apparatus 10 generates the statistical model that statistically estimates the number of users from the number of reception notifications for each shop S and estimates the number of users from the number of reception notifications received in the certain time using the generated statistical model. However, embodiments are not limited to this example.

When the shop S1 and the shop OS1 are shops positioned close to each other and share the same shop type “Italian restaurant”, it is estimated that the numbers of users who use the shop S1 and the shop OS1 are similar to each other, for example. When the shop S1 and the shop OS1 are similar to each other in an average price range used, or when they are similar to each other in evaluation contributed to the Internet, it is estimated that the numbers of users who use the shop S1 and the shop OS1 are more similar to each other. Given these circumstances, the estimation section 51 may estimate the number of users who are visiting the shop S1 on the basis of a statistical relation between the history of the number of notifications received from the terminal apparatus 100 of the user that has visited the shop OS1 similar to the shop S1 and the history of the using state of the shop OS1, for example. In other words, the information provision apparatus 10 may estimate the number of users who are visiting the shop S1 using a statistical model that estimates the number of users in the shop OS1.

The information provision apparatus 10 may use a statistical model for shops similar to each other in shop type or shop attribution. The information provision apparatus 10 generates a statistical model that estimates the number of users of the shop S1 on the basis of the histories of the numbers of reception notifications that the beacon signal indicating the shop S1 was received and reception notifications that the beacon signal indicating the shop OS1 was received and the history of the using state of the shop S1, for example. The information provision apparatus 10 may estimate the number of users of the shop S1 on the basis of the number of reception notifications received in a certain time, the reception notifications indicating either the beacon signal indicating the shop S1 or the beacon signal indicating the shop OS1. In other words, the information provision apparatus 10 may estimate, on the basis of the number of check-in performed on similar facilities at the same time, the number of users of any facility among the facilities. Using such an estimation model, the information provision apparatus 10 can improve the accuracy of estimating the number of users.

The information provision apparatus 10 may select similar facilities on the basis any standard. The information provision apparatus 10 may set similar facilities on the basis of any standard such as facilities close to each other, facilities similar to each other in use modes such as the amount of money used, a using time, and the number of people using the facility, facilities similar to each other in evaluation, facilities similar to each other in shop type such as the type of foods and drinks provided, and facilities similar to each other in the scale of shops or a combination of these standards, for example. The information provision apparatus 10 may generate a statistical model on the basis of a statistical relation between the number of check-in at similar facilities and the using state of any facility included in these facilities and estimate the number of people using the facility using the generated statistical model. The information provision apparatus 10 may regard a plurality of similar facilities as one facility, generate a statistical model, and estimate the number of people using all the facilities on the basis of the total of the number of users who have checked in at each of the facilities.

The information provision apparatus 10 may use a statistical model for each day or time zone. On the basis of a statistical relation between the history of reception notifications received at a date and time having certain commonness with a determination date and time at which it is determined whether a new user can use the shop S1 and the history of the using state of the shop S1 at the date and time, the estimation section 51 may estimate the number of users who are visiting the facility of the shop S1 at the determination date and time, for example. The information provision apparatus 10 generates a statistical model for Monday on the basis of the number of users who checked in at the shop S1 on Monday and the history of the using state on Monday, for example. When estimating the number of users of the shop S1 on Monday, the information provision apparatus 10 may estimate the number of users of the shop S1 from the statistical model on Monday on the basis of the number of reception notifications received in a certain time, that is, the number of check-in performed. The information provision apparatus 10 may generate a statistical model for, not only a day of the week, each time zone such as daytime or nighttime, each month, each season, or each weather and estimate the number of users using the statistical model corresponding to time zone, season, weather, or the like when estimating the number of users.

3-1-2. About Fullness/Vacancy Determination Using Behavior of Users

When the user U1 who has checked in at the shop S1 also checks in at the shop OS1 five minutes later or the like, it is estimated that the shop S1 was at full occupancy. Given these circumstances, when the number of users who visited the shop S1 and then visited the other shop OS1 within a certain time exceeds a certain threshold, the information provision apparatus 10 may determine that the shop S is at full occupancy regardless of the estimated number of users. When the number of terminal apparatuses 100 that have output a reception notification indicating visit to another facility for a lapse of a certain time after outputting a reception notification indicating visit to a certain shop exceeds a certain number, the shop state determination section 61 may determine that a new user cannot use the certain shop regardless of the estimation result, for example. When a plurality of terminal apparatuses 100 that output a reception notification indicating visit to the shop S output a reception notification indicating visit to another shop S continually for a lapse of a certain time, the information provision apparatus 10 may determine that a new user cannot use the shop S. The information provision apparatus 10 may correct the statistical model on the basis of such a determination result.

The information provision apparatus 10 may perform determination corresponding to the use history of a user. It is considered that the use history of each shop S by the user U1 shows tendencies of using the shop S by the user U1 such as whether the user U uses the shop alone or uses the shop in a group and an average using time, for example. Such tendencies of using the shop S by the user U1 can be indicators when it is determined whether the user U1 can use the shop S visited by the user U. When the user U uses the shop S in a group of ten on average, and when there are only two vacancies in the shop S, the user U cannot use the shop S, for example.

Given these circumstances, the information provision apparatus 10 determines whether the user U1 can use the shop S on the basis of the history of the use mode of the shop S by the user U1 and the estimation result. The information provision apparatus 10 estimates the tendency of the use mode of the shop OS1 common to the shop S1 to be determined in type on the basis of the history of the use mode of the shop S by the user U1 and determines whether the user U1 can use the shop S1 on the basis of the estimated tendency and the estimation result, for example. In other words, when the user U uses the shop S1, it is estimated that its use mode is similar to the use mode of the shop OS1 similar to the shop S1. Given these circumstances, the information provision apparatus 10 estimates a use mode when the user U1 used the shop OS1 from the use history and determines whether the user U1 can use the shop S1 on the basis of the estimated tendency and the estimated number of people using the shop S1.

The information provision apparatus 10 estimates an average number of people when the user U1 uses the shop OS1 from the history of the use mode of the shop OS1 by the user U1 and determines whether the user U1 can use the shop S1 on the basis of the estimated number of people and the estimated number of people using the shop S1, for example. When the user U1 visits the shop S1, the information provision apparatus 10 identifies a shop similar to the shop S1 used by the user U1 (the shop OS1, for example) from the use history of various kinds of shops S by the user U1 and identifies the amount of money used of the user U1 in the identified shop and the average amount of money used of the shop, for example.

The information provision apparatus 10 divides the amount of money used of the user U1 in the identified shop by the average amount of money used of the shop to estimate the number of people using the shop OS when the user U1 uses the shop OS similar to the shop S1. For a plurality of shops OS similar to the shop S1, the information provision apparatus 10 may estimate the number of people using each shop OS and calculate the average of the estimated number of people using the shops. The information provision apparatus 10 may estimate the number of users who can newly use the shop S1 from the number of users estimated for the shop S1 and, when the number of people using the shop, which is similar to the shop S1 and is intended to be used by the user U1, is larger than the number of users who can newly use the shop S1, determine that the user U1 cannot use the shop S1.

3-1-3. About Fullness/Vacancy Determination Using Attribution of Shop

The information provision apparatus 10 may determine whether a new user can use the shop S in accordance with the attribution of the shop S. When each table installed in the shop S is being used by one user, it may be at full occupancy, for example. However, when the shop S permits table sharing during lunchtime or the like, it is considered that a new user can use the shop S also in such a case.

Given these circumstances, the information provision apparatus 10 may determine whether a new user can use the shop S on the basis of information on the tables installed in the shop S, whether the shop S enables table sharing, and the estimated number of people using the shop S. The information provision apparatus 10 determines whether all the tables installed in the shop S are being used using the history of check-in, information acquired from the shop terminal ST, and the like, for example. When all the tables installed in the shop S are being used, and when the shop S is registered to enable table sharing at the time of determination (lunchtime, for example), the information provision apparatus 10 determines whether the estimated number of people using the shop S is the capacity of the shop S or less. When the estimated number of people using the shop S is less than the capacity of the shop S, the information provision apparatus 10 may determine that table sharing is enabled and determine that a new user can use the shop S.

3-1-4. About Determination Using Matching Between Conditions Desired by Shop and Users

The information provision apparatus 10 may determine whether the user U1 can newly use the shop S1 on the basis of the history of the use mode of each shop S by the user U1, conditions related to the use of the shop S1, and the estimated number of people using the shop S1. The information provision apparatus 10 performs matching between user conditions (an average number of people using the shop S1, an average amount of money used, or an average using period, for example) desired by the shop S1 and the use mode based on the use history of the user U to calculate the degree of matching between the user U1 and the shop S1, for example. For such a degree of matching, various kinds of method of score calculation can be applied. When the number of people using the shop S1 exceeds a certain threshold (exceeds 80% of the capacity, for example), the information provision apparatus 10 may determine that the user U1 can use the shop S1 only when the degree of matching exceeds a certain threshold. The information provision apparatus 10 may provide the user U1 with such a determination result.

3-1-5. About Reward Against Inquiry

When a user who made an inquiry responds, the information provision apparatus 10 may provide the user with a certain reward. When inquiring of the user U2 about the degree of congestion of the shop S1, and when the user U2 responds to the inquiry, for example, the information provision apparatus 10 may provide points to the user U2 or change the threshold to be compared with the using period in the privilege provision processing, for example. More specifically, when the user U2 responds to the inquiry, the information provision apparatus 10 may extend the using period that can provide a privilege from 2 hours to 3 hours.

3-2. About Modifications of Provision Processing

The following describes various kinds of modifications of the provision processing described above.

3-2-1. About First Condition

In the description of the provision processing described above, the information provision apparatus 10 determines whether the shop S1 visited by the user U is at full occupancy, whether the degree of congestion of the shop S1 exceeds the certain threshold, or the like as the first condition. However, embodiments are not limited to these examples. The information provision apparatus 10 may determine whether there are some waiting users in the shop S1 or whether the number of the waiting users in the shop S1 exceeds a certain threshold as the first condition and, when there are some waiting users in the shop S1 or when the number of the waiting users in the shop S1 exceeds the certain threshold, provide the user U1 with information on the other shop OS, for example.

When the number of people using the shop S1 estimated by the determination processing described above exceeds the capacity of the shop S1, the information provision apparatus 10 determines that waiting users WU exist as illustrated in FIG. 1, for example. When the waiting users WU exist, the information provision apparatus 10 may provide the user U1 with the information on the other shop OS. When the number of the waiting users WU exceeds the certain threshold, the information provision apparatus 10 may provide the user U1 with the information on the other shop OS.

Even when the waiting users WU exist, and when the average using time of the shop S1 is short, it is considered that the user U1 does not wait for a very long time. Given these circumstances, the information provision apparatus 10 may determine whether the using state of the shop S1 satisfies the first condition corresponding to the use mode of the shop S1. When the average using time of the shop S1 falls below a certain threshold, although the shop S1 is at full occupancy, the information provision apparatus 10 does not necessarily provide the user U1 with the information on the other shop, for example. When the average using time of the shop S1 falls below a certain first threshold (30 minutes, for example), although the shop S1 is at full occupancy, or when the average using time of the shop S1 falls below a second threshold shorter than the first threshold (15 minutes, for example), although there are some waiting users in the shop S1, the information provision apparatus 10 does not necessarily provide the user U1 with the information on the other shop. The information provision apparatus 10 may estimate the number of the waiting users WU and, when the using time of the shop S1 falls below a threshold corresponding to the estimated number of the waiting users WU, that is, a threshold that becomes smaller as the number of the waiting users WU increases, does not necessarily provide the user U1 with the information on other shop.

The information provision apparatus 10 may determine whether the first condition corresponding to the attribution of the user U1 is satisfied. The information provision apparatus 10 estimates a waiting time permitted by the user U on the basis of the behavior history and use history of the user U1, information registered in advance by the user U1, and the like, for example. When it can be estimated that a waiting time when the shop S1 is used exceeds the estimated waiting time, the information provision apparatus 10 may provide the user U1 with the information on the other shop OS.

The information provision apparatus 10 may calculate a score based on the various kinds of conditions described above, that is, a score corresponding to a time until the user U1 uses the shop S1 and set whether the calculated score exceeds a certain threshold as the first condition. Such a score may be calculated in accordance with whether the shop S1 is at full occupancy, whether there are some waiting users WU, the number of the waiting users WU, an average using time in the shop S1, a waiting time permitted by the user U1, or the like. Similarly, also for the second condition, the information provision apparatus 10 may calculate a score indicating similarity between the shop S1 and the shop OS1 and determine whether the calculated score exceeds a certain threshold.

3-2-2. Third Condition

In the description of the provision processing described above, when the shop S1 visited by the user U1 satisfies the certain first condition (when the shop S1 is at full occupancy, for example), the information provision apparatus 10 introduces a shop the relation with the shop S1 of which satisfies the second condition (a shop similar to the shop S1 in shop type or shop attribution such as the shop OS1, which is an Italian restaurant being the same as the shop S1, for example). However, embodiments are not limited to this example.

Even when the shop OS1 is introduced to the user U1, when the shop OS1 is at full occupancy, the user U1 is adversely impressed, for example. Given these circumstances, the information provision apparatus 10 may introduce a shop S the using state of which satisfies a third condition among shops S that satisfy the second condition to the user U1. The information provision apparatus 10 may introduce a shop S that is not at full occupancy among shops S similar to the shop S1 as the shop S that satisfies the third condition, for example. As a more specific example, the information provision apparatus 10 may introduce a shop S determined to be not at full occupancy by the determination processing described above to the user U1.

The information provision apparatus 10 may search for a shop S in which a time estimated to be required until it becomes able to be used does not exceed a certain threshold and introduce the shop S to the user U, for example. The information provision apparatus 10 selects the shop OS1 positioned closest to the shop S1 among the shops S similar to the shop S1, for example. In such a case, the information provision apparatus 10 estimates an average using time in the shop OS1. The information provision apparatus 10 calculates the average of the using period in the shop OS1, for example. Such processing can be achieved by processing similar to that of the acquisition section 81 described above, for example. The information provision apparatus 10 identifies users who are currently using the shop OS1 from the beacon log database 31 and identifies the use stating date and time of each of the identified users. The information provision apparatus 10 then estimates a date and time at which a vacancy occurs in the shop S1 on the basis of a comparison result between a time elapsed from the use starting date and time and the average using time in the shop OS1 and, when a time until the estimated date and time falls below a certain threshold (within 15 minutes, for example), may introduce the shop OS1 to the user U1

Similarly to the first condition described above, when the waiting time of the shop OS1 falls below a certain threshold or the waiting time permitted by the user U1 or the like, the information provision apparatus 10 may provide the user U1 with the information on the shop OS1. The information provision apparatus 10 may set the second condition in accordance with the distance between the shop S1 and the shop OS1. When the distance from the shop S1 to the shop OS1 exceeds a certain threshold, the information provision apparatus 10 estimates a moving time to the shop OS1, for example. When a time obtained by subtracting the moving time to the shop OS1 from a time in which a vacancy is estimated to occur in the shop OS1 falls below the waiting time permitted by the user U1, the information provision apparatus 10 may provide the user U1 with the information on the shop OS1.

The information provision apparatus 10 may set the third condition based on the use mode of the user U1. The information provision apparatus 10 estimates an average number of people using the shop S when the user U1 uses the shop S on the basis of an average amount of money used when the user U1 uses the shop S and an average amount of money used of the shop S used by the user U1 as described above, for example. The information provision apparatus 10 may determine whether there are vacancies corresponding to the estimated number of people in the shop OS1 and, when it is determined that there are vacancies, provide the user U1 with the information on the shop OS1.

Also for the third condition, the information provision apparatus 10 may calculate a score corresponding to the various kinds of using states of the shop OS1 (whether it is at full occupancy, the number of the waiting users WU, or an average using time, for example) and determine whether the calculated score exceeds a certain threshold.

3-2-3. Fourth Condition

The information provision apparatus 10 may search for the second facility that further satisfies a certain fourth condition according to the use history of shops by the user U1. The information provision apparatus 10 may search for a shop S the preregistered average estimated price of which falls within the average amount of money used when the user U1 uses the shop S and a certain range as the shop that satisfies the fourth condition, for example. The information provision apparatus 10 may estimate an average staying time when the user U1 uses the shop S (that is, whether the user U1 stays for a long time) and search for a shop S the preregistered staying time of which falls within the average staying time of the user U1 and a certain range as the shop S that satisfies the fourth condition.

In other words, when the tendency of the use mode of the shop S by the user U1 matches a condition designated by the shop OS1, the information provision apparatus 10 may provide the user U1 with the information on the shop OS1. In other words, the information provision apparatus 10 may provide each user U with information on the shop on the basis of information such as the number of visiting people on the basis of a past visiting history, a price range, or a time required for meal (a time predicted from a past average record, the attribution of the user U1, the attribution of the shop S1, or the like) on the basis of a condition whether the information matches condition designation from the shop. Such a tendency of the use mode may be registered in advance by the user U1.

Also for the fourth condition, the information provision apparatus 10 may calculate a score corresponding to the degree of matching between the use mode of the shop S by the user U1 and the using state of the shop OS1 and determine whether the calculated score exceeds a certain threshold. The information provision apparatus 10 may calculate a score that comprehensively determines the second condition, the third condition, and the fourth condition described above. In other words, for the shop OS1, the information provision apparatus 10 may calculate a score corresponding to the degree of similarity with the shop S visited by the user U1, whether the shop OS1 is at full occupancy or the number of the waiting users WU, the degree of matching with the use mode of the user U based on the use history of the user U, or the like and determine whether the calculated score exceeds a certain threshold.

In other words, the information provision apparatus 10 sets the third condition and the fourth condition to perform comparison (matching) between the shop OS similar to the shop S1 when viewed from a user and a user having a use tendency welcomed by the shop OS. Consequently, the information provision apparatus 10 can send a user in a more appropriate manner.

3-2-4. About Reservation of Introduced Shop

When providing the user U1 with the information on the shop OS1, the information provision apparatus 10 may receive a reservation for the shop OS1. The information provision apparatus 10 may provide the user U1 with contents for reserving the shop OS1 (that is, contents for making an instant reservation) together with the information on the shop OS1, for example.

When the user U1 makes an instant reservation for the shop OS1, the information provision apparatus 10 may notify the reserved shop OS1 of the fact that a reservation has been made, for example. In such a case, the shop OS1 may update its vacancy stock in real time. When the instant reservation has been made, the information provision apparatus 10 may regard the user U1 as having checked-in at the shop OS1 and execute various kinds of processing. When the user U1 makes an instant reservation, the information provision apparatus 10 may provide the user U1 with a certain privilege such as points or coupons that can be used in the shop S1 as a customer sending source or the shop OS1 as a customer sending destination.

To prevent getting points and coupons and escaping, the information provision apparatus 10 may provide a privilege that can be used only on the spot. The information provision apparatus 10 may provide the user U1 with points or coupons that can be used at the shop OS1 as a customer sending destination only at the time of reservation therefor, for example.

3-2-5. About Information Provision Timing

When the shop S1 satisfies the first condition not only at the timing when the user U1 actually visits the shop S1 but also at the timing when the user U1 is about to visit the shop S1, the information provision apparatus 10 may provide the user U1 with the information on the shop OS1. When it is estimated that the user U1 is moving toward the shop S1, or when it is estimated that the user U1 has entered a certain range from the shop S1 using the history of the positional information of the user U1 provided with the information on the shop S1 or the beacon signal received by the terminal apparatus 100, the information provision apparatus 10 may provide the user U1 with the information on the shop OS1, for example.

The information provision apparatus 10 may change timing to provide the user U1 with the information on the other shop OS1 in accordance with the using state of the shop S1. When it is determined that the shop S1 is at full occupancy, the information provision apparatus 10 provides the user U1 with the information on the shop OS1 at the timing when the distance between the user U1 and the shop S1 becomes shorter than a first threshold, for example. When the shop S1 is at full occupancy, and when the number of the waiting users WU exceeds a certain threshold, the information provision apparatus 10 may provide the user U1 with the information on the shop OS1 at the timing when the distance between the user U1 and the shop S1 becomes shorter than a second threshold, which is longer than the first threshold.

Such timing to provide the user U1 with the information on the shop OS1 may be determined in accordance with the distance between the user U1 and the shop S1, the time required for the user U1 to move to the shop S1, the current position of the user U1, the determination date and time, or the like, and any threshold can be employed. The information provision apparatus 10 may identify a route from the current position of the user U1 to the shop S1 and provide the user U1 with the information on the shop OS1 at a position that can be a branch point leading to the shop OS1 in the identified route, for example.

In other words, the information provision apparatus 10 may control timing to introduce the shop OS1, conditions to be introduced, or details to be introduced as appropriate from various kinds of information that can be acquired via the terminal apparatus 100 or the shop terminal ST. When the information (coupons, for example) on the shop S1 has been issued to the user U1, the information provision apparatus 10 may provide the user U1 with the information on the shop OS1 at least after causing the user U1 to move to the shop front of the shop S1, for example. The information provision apparatus 10 may provide the user U1 with the information on the shop OS1 after causing the user U1 to move to the shop front of the shop S1 only when the distance from the shop S1 to the shop OS1 is within a certain threshold.

When the shop OS1 is at full occupancy, the information provision apparatus 10 may further introduce the other shop OS similar to the shop OS1. In other words, the information provision apparatus 10 may repeatedly execute the processing described above. The information provision apparatus 10 may change a reward amount in accordance with an order in which shops have been introduced, for example. When providing a user who has moved from the shop S1 to the shop OS1 with information on a shop OS2 different from the shop OS1, the information provision apparatus 10 does not necessarily set a reward for customer sending for the shop OS1, for example.

3-3. About Modifications of Coupon Provision Processing

The following describes various modifications of the coupon provision processing described above.

3-3-1. About Comparison State

In the description of the coupon provision processing described above, it is determined that the user U1 is in a using state when the user U1 who has visited the shop S1 is provided with the information on the shop OS1. However, embodiments are not limited to this example. The comparison state determination section 71 may determine that the user U1 is in the comparison state when the user U1 cannot use the shop S1 when the user U1 visits the shop S1 the coupon of which has been provide to the user U1, for example. In other words, the comparison state determination section 71 may determine that the user U1 is in the comparison state when the user U1 cannot use the shop S1 visited in expectation of the use of the coupon.

The information provision apparatus 10 may identify the shop OS of the same type as the shop S1 (that is, the shop OS similar to the shop S1) as the other shop OS competing with the shop S1 and determine whether the user U1 is in the comparison state that compares the shop S1 and the identified shop OS with each other. The information provision apparatus 10 may identify the shop OS located within a certain range from the shop OS1 as the other shop OS competing with the shop S1 and determine whether the user U1 is in the comparison state that compares the shop S1 and the identified shop OS with each other. The information provision apparatus 10 may determine that the user U1 is in the comparison state only when the shop OS1 the information of which has been provided to the user U1 and the shop S1 are similar to each other, or when the shop S1 and the shop OS1 are located within a certain range, for example. In other words, the information provision apparatus 10 may regard shops S similar to each other or located within a certain range as shops S competing with each other and determine whether the user U1 is in the comparison state that compares the competing shops S with each other.

3-3-2. About Selection of Special Coupon

When there are a plurality of shops that are compared with the shop S1 and compete with the shop S1, the information provision apparatus 10 provides the user U1 with the special coupons issued by the individual competing shops. The information provision apparatus 10 may make only one special coupon selected by the user U1 able to be used among the provided special coupons and provide the user U1 with only information on the shop S corresponding to the selected special coupon. In other words, in the provision processing described above, the information provision apparatus 10 may provide the user U1 with the special coupons of the individual shops OS before providing the user U1 with the information on the shop OS different from the shop S1 visited by the user U1 and provide the user U1 with only information on the shop OS corresponding to the special coupon selected by the user U1.

3-3-3. About Display of Special Coupon

When the user U1 selects the provided special coupon, that is, when the user U expresses an intention to use the special coupon, the information provision apparatus 10 continues to provide the user U with the special coupon. In other words, when the user U1 selects the provided special coupon, the information provision apparatus 10 maintains the special coupon at a state that can be referred to by the user U1 until the special coupon is used even when the comparison state is cleared.

3-3-4. About Details of Special Coupon

The information provision apparatus 10 may set the details of the special coupon on the basis of any information other than the information on the coupon issued by the shop S1 as a customer sending source. The information provision apparatus 10 may provide the user U1 with the special coupon with details corresponding to the attribution of the user U1, for example. When providing the user U1 with the special coupon of the shop OS1, the information provision apparatus 10 may estimate the use mode of the shop OS1 by the user U1 on the basis of the use history of each shop S by the U1 and provide the user U1 with the special coupon with details corresponding to the estimated use mode.

The information provision apparatus 10 estimates the amount of money used or a using time when the user U1 uses the shop OS1, for example. The information provision apparatus 10 estimates the amount of money used or a using time when the user U1 uses the shop OS. Such estimation can be achieved on the basis of the use history of each shop S by the user U1 as described above. The information provision apparatus 10 may estimate the use mode of the shop OS1 by the user U1 on the basis of the use history of the shop S similar to the shop OS1 in the history using the shop OS by the user U1, for example.

The information provision apparatus 10 sets the details of the special coupon on the basis of the estimated use mode itself or a matching result between the estimated use mode and conditions registered in advance by the shop OS1. When the estimated amount of money used or number of people using the shop OS1 exceeds a certain threshold, when the using time falls below a certain threshold, or the like, the information provision apparatus 10 may set the special coupon with a more favorable condition (that is, a coupon with a large benefit for the user U1), for example. In other words, the information provision apparatus 10 may set the special coupon with a more favorable condition in accordance with the use record (an actual unit price or a staying time, for example) of the shop S. The information provision apparatus 10 may set the details of the special coupon in accordance with whether the estimated use mode satisfies conditions such as the threshold of the amount of money used, the threshold of the number of people using the shop OS1, and the threshold of the using time set by the shop OS1.

It is considered that customers decrease in rainy days or the like. Given these circumstances, the information provision apparatus 10 may set the special coupon as the special coupon with the details corresponding to information on weather. The information provision apparatus 10 may acquires weather information from a certain server apparatus and set the details of the special coupon in accordance with weather, atmospheric temperature, and the like indicated by the acquired weather information, for example.

The information provision apparatus 10 may set the details of the special coupon automatically on the basis of the setting of the other shop S positioned around the shop OS1 that provides the user U1 with the special coupon. When the majority of the other shops S positioned around the shop OS1 issue a 20% discount coupon, the information provision apparatus 10 may set the special coupon with 20% discount similarly, for example. The information provision apparatus 10 may perform weighting on the details of the coupons set by the other shops S positioned around the shop OS1 according to the distance from the shop OS1 and set the details of the special coupon on the basis of the result of weighting.

The information provision apparatus 10 may estimate the presence or absence of a tendency to move to the shop S introduced by the provision processing described above from the behavior history of the user U1 and, when it is estimated that there is a tendency to move to the introduced shop S, provide the user U1 with the special coupon with a further more favorable condition. The information provision apparatus 10 may count the number of times the user U1 visited the shop introduced by the provision processing described above and, when the counted number of times exceeds a certain threshold, provide the user U1 with the special coupon with a more favorable condition together with information on the shop S, for example.

Such setting of the special coupon can be achieved by changing application conditions such as free provision of a certain article, tax-included and before-tax prices, the number of people, a day, a time zone, a discount rate, and being limited to rainy days or numerical values set for each of the application conditions, for example. What application condition is set in what state, how the value set for each of the application conditions is changed in what state, the upper limit of the values, and the like are set in advance by the shop S that provides the user U1 with the special coupon.

When the shop S sets the special coupon, the information provision apparatus 10 may provide the shop S with a selection screen for settable conditions and numerical values (that is, a coupon pattern) and employ the special coupon with the details selected by the shop S on the provided selection screen. Such a selection screen may display the condition and numerical values of coupons set by other shops competing with the shop S to facilitate setting of a coupon to be provided when compared with these coupons, for example.

3-3-5. Variations of Comparison State

The information provision apparatus 10 may provide the user U1 with the special coupon at any state so long as it is a state in which it is estimated that the user U1 is comparing a plurality of shops S with each other. When the user U1 registers a plurality of shops in favorites or selects a plurality of shops using a checkbox such as “compare collectively” in shop search on the web, the information provision apparatus 10 may determine that the user U1 is in the comparison state, for example. In other words, when it can be estimated that the user U1 is comparing a plurality of shops with each other on the basis of the behavior of the user U1, the information provision apparatus 10 may determine that the user U1 is in an comparing state.

3-4. About Modifications of Privilege Provision Processing

The following describes various modifications of the privilege provision processing described above.

3-4-1. About Privilege Provided

Other than points, the information provision apparatus 10 may provide the user U2 with any privilege so long as it provides the user U2 with a benefit such as various kinds of coupons. The information provision apparatus 10 may provide the user U2 with coupons and points that can be used only in shops that were used by the user U2.

The information provision apparatus 10 may provide the user U2 with the information on the other shop OS different from the shop S1 and provide the user U2 with coupons and points that can be used in the shop OS as a privilege. The information provision apparatus 10 notifies the user U2 of the use ending date and time at which a privilege is provided, and provides the user U2 with information on the other shop OS that can be used from the use ending date and time, for example. The information provision apparatus 10 may provide the user U2 with the information on the shop OS similar to the shop S1 being used by the user U2. The information provision apparatus 10 may receive an instant reservation for the shop OS.

When the user U2 agrees to leave the shop S1 at the use ending date and time notified of, when an instant reservation for the other shop OS notified of is made, and when the user U2 leaves the shop S1 at the use ending date and time notified of, the information provision apparatus 10 may provide the user U2 with a coupon that can be used in the shop OS.

The information provision apparatus 10 may provide the user U2 with a privilege with details corresponding to the length of the using period of the user U2. In other words, the information provision apparatus 10 may provide the user with a certain privilege corresponding to the period from the use starting date and time to the use ending date and time. The information provision apparatus 10 may provide larger points when the using time of the user U2 is shorter, for example. The information provision apparatus 10 may provide the user U2 with a reward according to the amount of money used. The information provision apparatus 10 may provide the user U2 with an addition of a certain fixed point and a point of a value obtained by multiplying the amount of money used of the shop S1 by a certain rate, for example.

3-4-2. About Privilege Provision Mode

The information provision apparatus 10 may provide the user U2 with a privilege in any manner. When the using period of the user U2 is identified from the information registered in the beacon log database 31 in an ex post manner a few days after use of the shop S1 by the user U2, and when the identified using period falls below a certain threshold, the information provision apparatus 10 may provide the user U2 with a privilege, for example.

When a certain period elapses from the use starting date and time, the information provision apparatus 10 may provide the user U2 with part of the privilege. When a privilege is provided when the using period is within 2 hours, the information provision apparatus 10 may provide the user U2 with part of the privilege (half the points, for example) 1 hour after the user U2 started the use of the shop S1, for example. When the user U2 leaves the shop S1 after the part of the privilege has been provided, the information provision apparatus 10 determines whether the using period was within 2 hours. When the using period was within 2 hours, the information provision apparatus 10 may provide the user U2 with the residual point. When the using period exceeds 2 hours even though the part of the privilege has been provided, the information provision apparatus 10 may cancel the part of the privilege provided to the user U2. The information provision apparatus 10 may provide the user U2 with the privilege separately at a date and time at which the user U2 visited the shop S1 and a date and time at which the user U2 left the shop S1 using the beacon.

When the user U2 receives information (coupons, for example) on the shop S1 in advance, when the user U2 actually uses the shop S1, and when a usable period falls below a certain threshold, the information provision apparatus 10 may provide a privilege.

3-4-3. About Use by Group

When the user U2 is a group that is simultaneously using the shop S1, the information provision apparatus 10 may acquire the use starting date and time and the use ending date and time of the group and provide the user U2 or provide all the users contained in the group with a privilege in accordance with the period from the use starting date and time to the use ending date and time. The information provision apparatus 10 may provide the user U2 with a privilege according to the number of people of the group containing the user U2. The information provision apparatus 10 may provide the user U2 with more privileges as the number of members of group containing the user U2 increases, for example.

3-4-4. About Using Period

The information provision apparatus 10 may set any timing as the use starting date and time so long as it is timing considered to be appropriate as the date and time at which the user U2 started the use of the shop S1. The information provision apparatus 10 may set any timing as the use ending date and time so long as it is timing considered to be appropriate as the date and time at which the user U2 ended the user of the shop S1.

The information provision apparatus 10 acquires the use starting date and time and the use ending date and time with the check-in of the user U2 at the shop S1 as an impetus, for example. However, embodiments are not limited to this example. When receiving reception notifications indicating the beacon ID of the shop S1 from the terminal apparatus 100 used by the user U2 continually for a certain period, the information provision apparatus 10 may set a date and time at which a reception notification indicating the beacon ID of the shop S1 was received for the first time as the use starting date and time, for example.

The information provision apparatus 10 may identify a date and time at which the user U2 visited the shop S1 from a position history as the history of a position acquired by the terminal apparatus 100 using Global Positioning System (GPS) or the like, for example, without using the beacon and set the identified date and time as the use starting date and time. The information provision apparatus 10 may identify a date and time at which the user U2 left the shop S1 from the position history and set the identified date and time as the use ending date and time. The information provision apparatus 10 may cause the shop S1 to print a barcode indicating a date and time on a receipt when the user U2 paid the bill in the shop S1, cause the terminal apparatus 100 to read the barcode, and cause the terminal apparatus 100 to transmit the date and time shown by the barcode to the information provision apparatus 10 to acquire the date and time at which the user U2 paid the bill in the shop S1, for example. In other words, the information provision apparatus 10 may acquire the date and time at which the user U2 started the use of the shop S1 and the date and time at which the user U2 ended the use of the shop S1 on the basis of any methods or information.

It is considered that what timing is set as the use starting date and time and the use ending date and time changes by article, services, and the like provided by the shop S1. Given these circumstances, the information provision apparatus 10 may acquire a date and time at which a certain action according to the business category of the shop S1 was performed as the use starting date and time and the use ending date and time. When the shop S1 is a facility that provides foods and drinks, the information provision apparatus 10 may acquire a date and time at which certain foods and drinks were provided as the use starting date and time, for example. As a more specific example, the information provision apparatus 10 may acquire a date and time at which the provision of certain foods and drinks or more has completed such as a date and time at which all of foods and drinks or the majority of foods and drinks ordered by the user U2 at the beginning were provided, a date and time at which certain drinks among the foods and drinks ordered by the user U2 at the beginning were provided, or a date and time at which all the drinks and the majority of the foods were provided as the use staring date and time. Such a use starting date and time can be acquired by the acquisition of the date and time at which foods and drinks were provided from the shop terminal ST or by operating the terminal apparatus 100 of the user U2 by a clerk of the shop S1, for example.

The information provision apparatus 10 may acquire a date and time at which the user U2 paid the bill along with the use of the shop S1 or a date and time at which the user U 2 left the shop S1 as the use ending date and time. The information provision apparatus 10 may set a date and time at which a notification that payment ended was received from the shop terminal ST as the use ending date and time, for example; when electronic payment using the terminal apparatus 100 was executed, the information provision apparatus 10 may set timing at which the electronic payment was executed as the use ending date and time, for example. The information provision apparatus 10 may set a date and time at which the terminal apparatus 100 becomes not to receive the beacon ID of the shop S1 as the use ending date and time.

In the example described above, the information provision apparatus 10 provides the user U2 with a privilege when the using period falls below the certain threshold. However, embodiments are not limited to this example. It is considered that the average using time in the shop S1 changes by the business category of the shop S1, for example. As a more specific example, it is considered that the average using time of the shop S that provides fast foods is shorter than that of a general restaurant. Given these circumstances, when the period from the use starting date and time to the use ending date and time is a period corresponding to the business category of the shop S1 or shorter, the information provision apparatus 10 may provide the user U2 with a privilege. When the using period of the user U2 falls below the average using period of the shop S1, the information provision apparatus 10 may provide the user U2 with a privilege, for example. Such a threshold of the using period may be automatically set from an average using time when each user uses the shop S1, or a period set in advance by the shop S1 may be employed.

When the shop S1 is congested, it is considered that a demand for causing the user U2 to leave the shop S1 earlier occurs in the shop S1. In contrast, when the shop S1 is not congested, it is considered that if the user U2 is caused to leave the shop S1 earlier, harmful effects such as degradation of impression about the shop S1 and a reduction in order opportunity occur. Given these circumstances, the information provision apparatus 10 may determine whether the user U2 is provided with a privilege on the basis of whether the using period exceeds a threshold according to the using state of the shop S1. More specifically, the information provision apparatus 10 may provide the user U2 with a privilege in accordance with the period from the use starting date and time to the use ending date and time and a period based on the using state of the shop S1.

The information provision apparatus 10 identifies the vacancy state of the shop S1 as the using state of the shop S1, for example. The information provision apparatus 10 may estimate the number of users who are using the shop S1 using the beacon described above and determine the vacancy state of the shop S1 from an estimation result, for example. The information provision apparatus 10 may acquire the vacancy state of the shop S1 from the shop terminal ST. When the vacancy state satisfies a certain condition, the information provision apparatus 10 extends a period based on the using state of the facility. When the degree of congestion falls below a certain threshold, the information provision apparatus 10 extends the period based on the using state of the facility from 2 hours to 3 hours, for example. When the degree of congestion exceeds the certain threshold, the information provision apparatus 10 may reduce the period based on the using state of the facility from 2 hours to 1.5 hours, for example. When the using period is shorter than the period based on the using state of the facility, the information provision apparatus 10 may provide the user with a certain privilege.

The information provision apparatus 10 may implement the processing described above by correcting the using period in accordance with a shop state. The information provision apparatus 10 causes the terminal apparatus 100 of the user U2 to display a timer until the use ending date and time at which a privilege is provided, for example. When a clerk of the shop S1 performs a temporary stop operation on the timer via the terminal apparatus 100 or the shop terminal ST when the shop S1 is vacant, the information provision apparatus 10 temporarily stops the timer, for example. When a clerk performs a starting operation on the timer when the shop S1 becomes congested or the like, the information provision apparatus 10 resumes the progress of the timer. When the value of the timer does not exceed a certain threshold when the user U2 leaves the shop S1 or the like, the information provision apparatus 10 may provide the user U2 with a privilege.

Thus, the information provision apparatus 10 may change conditions for providing a privilege in accordance with the fullness/vacancy state of the shop S1. When a condition for providing a privilege is changed, the information provision apparatus 10 may present the changed condition to the user U2 each time. The information provision apparatus 10 does not necessarily change conditions disadvantageous for the user U2, for example.

The shop S1 may want to urge the user U2 to leave the shop S1 when the total amount of money used of the user U2 is small and want to make the user U2 use the shop S1 continuously when the total amount of money used thereof is large. Given these circumstances, the information provision apparatus 10 may provide the user with a privilege in accordance with the period from the use starting date and time to the use ending date and time and the amount of money used of the shop S1. The information provision apparatus 10 may extend a using period that provides the user U2 with a privilege to 3 hours when the amount of money used at the shop S1 exceeds a certain threshold for a lapse of a certain time after the entry of the user U2 and limit the using period that provides the user U2 with a privilege to 2 hours when the amount of money used of the shop S1 falls below the certain threshold, for example.

3-5. Application to Shop Group

In the processing described above, the information provision apparatus 10 executes the determination processing, the provision processing, the coupon provision processing, and the privilege provision processing described above for each shop S. Given these circumstances, the information provision apparatus 10 may execute the various kinds of processing described above for each shop group containing a plurality of shops. The information provision apparatus 10 regards a first shop building in which a plurality of restaurant-related shops are located and a second shop building that is positioned within a certain range from the first shop building and in which a plurality of restaurant-related shops are located similarly to the first shop building as a single shop each, for example.

When the user U1 moves to the entrance of the first shop building, the information provision apparatus 10 may determine whether all the shops of the first shop building are at full occupancy and, when it is determined that they are at full occupancy, provide the user U1 with information on the second shop building or other shops located in the second shop building. The information provision apparatus 10 may introduce another shop located in the second shop building, the shop similar in type to a shop visited and used by the user U1 (a shop having a coupon, for example).

The information provision apparatus 10 may, for the first shop building and the second shop building each, determine whether each shop is at full occupancy or the degree of congestion and integrate the degree of satisfaction of the shops to estimate the degree of satisfaction of the first shop building and the second shop building. The information provision apparatus 10 may issue the special coupon for the first shop building and the second shop building each. The information provision apparatus 10 may identify a using time for the first shop building and the second shop building each and provide the user U1 with a privilege according to the identified using time. When the using period of a first shop contained in the first shop building satisfies a certain condition, the information provision apparatus 10 may provide the user U1 with a coupon of a second shop contained in the first shop building as a privilege.

3-6. Others

The embodiment is only by way of example, and the present invention includes embodiments exemplified below and other embodiments apart therefrom. The functional configuration, the data structure, and the order and the details of the pieces of processing indicated in the flowcharts in the present application are only by way of example, for example; the presence or absence, the arrangement and the order of processing execution and the like, the specific details, and the like of the elements can be changed as appropriate. The provision processing, the determination processing, the coupon provision processing, and the privilege provision processing described above can also be implemented as apparatuses, methods, and computer programs in a cloud system apart from the implementation by the information provision apparatus 10 as exemplified in the embodiment, for example.

The whole or part of the processing described as being automatically performed among the pieces of processing described in the embodiment can also be performed manually; on the contrary, the whole or part of the processing described as being manually performed can also be performed automatically by known methods. In addition, information including the processing procedure, the specific names, the various kinds of data and parameters indicated in the text and the drawings can be freely changed except cases specified. The various kinds of information illustrated in the drawings are not limited to the illustrated pieces of information, for example.

The components of each illustrated apparatus are functionally conceptual and are not necessarily required to be configured as physically illustrated. In other words, the specific mode of the distribution and integration of each apparatus is not limited to the illustrated one; the whole or part thereof can be configured by being distributed or integrated functionally or physically by any unit in accordance with various kinds of loads, using states, and the like.

The embodiments can be combined with each other as appropriate to the extent that processing details are not contradictory to each other.

4. Effects

As described above, from the terminal apparatus having the notification function to output, when a user visits a certain facility, a notification that the user has visited the facility, the information provision apparatus 10 receives the notification. The information provision apparatus 10, on the basis of the statistical relation between the history of the number of the notification and the history of the using state of the facility, estimates the number of users who are visiting the certain facility from the number of notifications received in a certain period. The information provision apparatus 10 then determines whether a new user can use the certain facility on the basis of the estimation result. Consequently, the information provision apparatus 10 appropriately estimates the number of users who are visiting the facility even when the users of the terminal apparatus having the communication function are only part of all the users and can thus achieve fullness/vacancy determination on the facility with high precision.

The information provision apparatus 10 estimates the number of users who are visiting the certain facility on the basis of the ratio between the number of notifications received in a certain time zone and the number of users who used the certain facility in the certain time zone. The information provision apparatus 10 determines whether a new user can use the certain facility on the basis of a comparison result between the estimated number of users and the number of users who can use the certain facility. Consequently, the information provision apparatus 10 can achieve fullness/vacancy determination on the facility with high precision.

The information provision apparatus 10 further receives information indicating the using state of the certain facility from a terminal apparatus installed in the certain facility. The information provision apparatus 10 estimates the number of users who are visiting the certain facility on the basis of the statistical relation between the history of the number of the notification and the history of the using state of the certain facility. Consequently, the information provision apparatus 10 can achieve fullness/vacancy determination on the current facility with high precision on the basis of the relation between the using state of the facility in the past and the number of users of the terminal apparatus having the communication function.

When receiving a notification, the information provision apparatus 10 inquires of a terminal apparatus serving as an output source of the notification about the using state of the certain facility. The information provision apparatus 10 inquires about whether a new user can use the certain facility as the using state of the certain facility, for example. When the terminal apparatus serving as the output source of the notification contributes certain information to a network, the information provision apparatus 10 inquires about the using state of the certain facility, for example. Consequently, the information provision apparatus 10 can perform fullness/vacancy determination on the current facility on the basis of the impression of the user who is actually using the facility.

When the relation between the estimated number of users and the number of users who can use the certain facility satisfies a certain condition, the information provision apparatus 10 inquires about the using state of the certain facility. When the difference between the estimated number of users and the number of users who can use the certain facility falls within a certain range, the information provision apparatus 10 inquires about the using state of the certain facility, for example. Consequently, in a state in which the accuracy of the determination result based on the estimated number of users is prone to degrade, the information provision apparatus 10 performs fullness/vacancy determination on the current facility on the basis of the impression of the user who is actually using the facility and can thus improve the accuracy of the determination result.

The information provision apparatus 10 corrects the statistical relation between the history of the number of notifications and the history of the using state of the facility on the basis of the inquiry result. The information provision apparatus 10 estimates the number of users who are visiting the certain facility on the basis of the corrected relation. Consequently, the information provision apparatus 10 can continually improve the estimation accuracy.

The information provision apparatus 10 estimates the number of users who are visiting the certain facility on the basis of the statistical relation between the history of the number of notifications received from the terminal apparatus that visited a facility similar to the certain facility and the history of the using state of the facility similar to the certain facility. Consequently, the information provision apparatus 10 can, by the type of the facility, estimate the number of users who are visiting the facility of the type on the basis of the statistical relation between the history of the number of notifications and the history of the using state.

On the basis of the statistical relation among a determination date and time at which it is determined whether a new user can use a certain facility, the history of the number of notifications received at a date and time having certain commonness, and the history of the using state of the facility at the date and time, the information provision apparatus 10 estimates the number of users who are visiting the certain facility at the determination date and time. Consequently, the information provision apparatus 10 can estimate the number of users who are visiting the facility on the basis of the statistical relation between the history of the number of notifications and the history of the using state for each date and time or day at which the facility is used.

When the number of terminal apparatuses that have output a notification indicating visit to another facility for a lapse of a certain time after outputting a notification indicating visit to a certain facility exceeds a certain number, the information provision apparatus 10 determines that a new user cannot use the certain facility regardless of the estimation result. Consequently, the information provision apparatus 10 can prevent false determination in a case clearly determinable to be at full occupancy.

The information provision apparatus 10 determines whether a new user can use the certain facility on the basis of the history of the use mode of the facility by the user and the estimation result. The information provision apparatus 10 estimates the tendency of the use mode of a facility common to the certain facility in type on the basis of the history of the use mode of the facility by the user and determines whether a new user can use the certain facility on the basis of the estimated tendency and the estimation result by the estimation section, for example. As a more specific example, the information provision apparatus 10 estimates an average number of people when the user uses the facility from the history of the use mode of the facility by the user and determines whether a new user can use the certain facility on the basis of the estimated number of people and the number of users estimated by the estimation section. The information provision apparatus 10 determines whether a new user can use the certain facility on the basis of information on tables installed in the certain facility, whether the certain facility enables table sharing, and the estimation result. Consequently, the information provision apparatus 10 can achieve fullness/vacancy determination according to the user.

The information provision apparatus 10 determines whether a new user can use the certain facility on the basis of the history of the use mode of the facility by the user, conditions related to the use of the certain facility, and the estimation result. Consequently, the information provision apparatus 10 can achieve fullness/vacancy determination according to a matching result between the history of the use mode of the user and conditions required for the user by the facility.

The embodiments of the present application have been described in detail on the basis of the drawings; these are by way of example, and the present invention can be performed in other modes on which various modifications and improvements have been made on the basis of the knowledge of those skilled in the art, including the modes described in the disclosure of the invention.

The “section” described above can be read as “means”, “circuit”, or the like. The selection section may be read as selection mean or a selection circuit, for example.

A mode of the embodiment can estimate full occupancy more appropriately even when users of terminal apparatuses that do not have a notification function are mixed in users who visit facilities.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A determination apparatus comprising:
a reception unit that receives a notification, indicating that a user has visited a certain facility, from a terminal apparatus having a notification function that outputs the notification when the user visits the facility;
an estimation unit that estimates, on the basis of a statistical relation between a history of number of the notifications and a history of a using state of the facility, number of users who are visiting the certain facility from number of the notifications received in a certain period; and
a determination unit that determines whether a new user is able to use the certain facility on the basis of a determination result by the estimation unit.

2. The determination apparatus according to claim 1, wherein the estimation unit estimates the number of users who are visiting the certain facility on the basis of a ratio between number of notifications received in a certain time zone and number of users who have used the certain facility in the certain time zone.

3. The determination apparatus according to claim 1, wherein the determination unit determines whether a new user is able to use the certain facility on the basis of a comparison result between the number of users estimated by the estimation unit and number of users who are able to use the certain facility.

4. The determination apparatus according to claim 1, wherein
the reception unit further receives information indicating a using state of the certain facility from a terminal apparatus installed in the certain facility, and
the estimation unit estimates the number of users who are visiting the certain facility on the basis of a statistical relation between the history of the number of the notifications and a history of the using state of the certain facility.

5. The determination apparatus according to claim 1, further comprising an inquiry unit that, when the reception unit receives the notification, inquires of a terminal apparatus serving as an output source of the notification about a using state of the certain facility.

6. The determination apparatus according to claim 5, wherein the inquiry unit inquires about whether a new user is able to use the certain facility as the using state of the certain facility.

7. The determination apparatus according to claim 5, wherein the inquiry unit inquires about the using state of the certain facility when the terminal apparatus serving as the output source of the notification contributes certain information to a network.

8. The determination apparatus according to claim 5, wherein the inquiry unit inquires about the using state of the certain facility when a relation between the number of users estimated by the estimation unit and the number of users who are able to use the certain facility satisfies a certain condition.

9. The determination apparatus according to claim 8, wherein the inquiry unit inquires about the using state of the certain facility when a difference between the number of users estimated by the estimation unit and the number of users who are able to use the certain facility falls within a certain range.

10. The determination apparatus according to claim 5, further comprising a correction unit that corrects the statistical relation between the history of the number of the notifications and the history of the using state of the facility on the basis of an inquiry result by the inquiry unit, wherein
the estimation unit estimates the number of users who are visiting the certain facility on the basis of the relation corrected by the correction unit.

11. The determination apparatus according to claim 1, wherein the estimation unit estimates the number of users who are visiting the certain facility on the basis of a statistical relation between a history of number of notifications received from a terminal apparatus that visited a facility similar to the certain facility and a history of a using state of the facility similar to the certain facility.

12. The determination apparatus according to claim 1, wherein on the basis of a statistical relation between a history of number of the notifications received at a date and time having certain commonness with a determination date and time at which whether a new user is able to use the certain facility is determined and a history of a using state of the facility at the date and time, the estimation unit estimates the number of users who are visiting the certain facility at the determination date and time.

13. The determination apparatus according to claim 1, wherein the determination unit determines that a new user is not able to use the certain facility regardless of the estimation result by the estimation unit when number of terminal apparatuses that have output a notification indicating visit to another facility for a lapse of a certain time after outputting a notification indicating visit to the certain facility
exceeds a certain number.

14. The determination apparatus according to claim 1, wherein the determination unit determines whether a new user is able to use the certain facility on the basis of a history of a use mode of the facility by the user and the estimation result by the estimation unit.

15. The determination apparatus according to claim 14, wherein the determination unit estimates a tendency of a use mode of a facility common to the certain facility in type on the basis of the history of the use mode of the facility by the user and determines whether a new user is able to use the certain facility on the basis of the estimated tendency and the estimation result by the estimation unit.

16. The determination apparatus according to claim 14, wherein the determination unit estimates an average number of people when the user uses the facility from the history of the use mode of the facility by the user and determines whether a new user is able to use the certain facility on the basis of the estimated number of people and the number of users estimated by the estimation unit.

17. The determination apparatus according to claim 1, wherein the determination unit determines whether a new user is able to use the certain facility on the basis of information on tables installed in the certain facility, whether the certain facility enables table sharing, and the estimation result by the estimation unit.

18. The determination apparatus according to claim 1, wherein the determination unit determines whether a new user is able to use the certain facility on the basis of the history of the use mode of the facility by the user, conditions related to use of the certain facility, and the estimation result by the estimation unit.

19. A method of determination executed by a determination apparatus, the method comprising:
receiving a notification, indicating that a user has visited a certain facility, from a terminal apparatus having a notification function that outputs the notification when the user visits the facility;
estimating, on the basis of a statistical relation between a history of number of the notifications and a history of a using state of the facility, number of users who are visiting the certain facility from number of the notifications received in a certain period; and
determining whether a new user is able to use the certain facility on the basis of a determination result at the estimating.

20. A non-transitory computer-readable storage medium having stored therein a determination program that causes a computer to execute a process comprising:
receiving a notification, indicating that a user has visited a certain facility, from a terminal apparatus having a notification function that outputs the notification when the user visits the facility;
estimating, on the basis of a statistical relation between a history of number of the notifications and a history of a using state of the facility, number of users who are visiting the certain facility from number of the notifications received in a certain period; and
determining whether a new user is able to use the certain facility on the basis of a determination result at the estimating.
